(19) United States
(12) Patent Application Publication
(10) Pub. No.: US 2017/0329915 A1
(43) Pub. Date: Nov. 16, 2017

(54) SYSTEMS AND METHODS FOR GENERATING A MODULAR WEB PAGE TEMPLATE TO DISPLAY PERSONAL GENETIC AND PHYSIOLOGICAL CONDITION INFORMATION

(71) Applicant: 23andMe, Inc., Mountain View, CA (US)

(72) Inventors: Bradley Kittredge, San Francisco, CA (US); Magdalene Misztal, Mountain View, CA (US); Shirley Wu, Mountain View, CA (US); Bertram Koelsch, Mountain View, CA (US); Jie Wei, Mountain View, CA (US); Pei Lun Shan, San Francisco, CA (US); Robert John Borkowski, Mountain View, CA (US)

(21) Appl. No.: 15/249,242

(22) Filed: Aug. 26, 2016

Related U.S. Application Data
(60) Provisional application No. 62/210,905, filed on Aug. 27, 2015.
(60) Provisional application No. 62/244,128, filed on Oct. 20, 2015.

(51) Int. Cl. G06F 19/00; G06F 19/18

(52) U.S. Cl. CPC G06F 19/345; G06F 19/18

(57) ABSTRACT

The disclosed inventions relate to web page templates and methods for constructing web pages, including web pages for the display of personal medical, genetic, and diagnostic information related to a physiological condition including, but not limited to, a medical condition, a trait, and a wellness condition.

### CROSS-REFERENCE TO RELATED APPLICATIONS

This application claims benefit under 35 U.S.C. §119(e) to U.S. Provisional Patent Application No. 62/210,905, filed Aug. 27, 2015, and to U.S. Provisional Patent Application No. 62/244,128, filed Oct. 20, 2015, which are herein incorporated by reference in their entirety.

### FIELD OF THE INVENTION

The invention generally relates to a web page template for displaying personal genetic and other medical and physiological information on a web page.

### BACKGROUND OF THE INVENTION

Technological advances have made individual genetic information increasingly affordable and accessible through a variety of genetic testing services. An individual may obtain a detailed genetic analysis by providing a small biological sample (e.g., saliva sample or tissue sample collected using a cheek swab). An analysis of the subject's DNA provides a wealth of detailed medical information regarding the subject's susceptibility to certain genetically-linked conditions and diseases, their response to certain drugs or medications, and the likelihood of passing variants that can cause heritable diseases or conditions to their offspring, even if the subject him/herself is not afflicted with that disease or condition (i.e., is a carrier).

The volume and complexity of these data present a challenge to non-expert individuals understanding personal genetic information as well as medical professionals in communicating with patients. The challenge is several-fold. First, modern analytical techniques facilitate the rapid and inexpensive screening of thousands of individual genetic mutations and/or sequence the entire genome of the individual, thereby generating a large number of individual test results that must be communicated to the individual. Second, these data are being communicated to a lay-person who often lacks any medical training and in the absence of a physician (or with minimal input from a physician). Thus, there is a need to present the personal genetic information, and related information about the interpretation of that genetic information, in a manner that is clear and highly comprehensible to a lay-person.

### SUMMARY OF THE INVENTION

The disclosed embodiments include a method for constructing a web page. The method includes generating an electronic template for a web page using a processor of a computing platform. The template comprises a plurality of modules arranged in a manner that effectively displays the user's information along with educational, interpretive, and other information to aid the user in understanding the displayed personal information. Although numerous modules are disclosed and described, it is understood that not every module will be present in every web page template. The template may be modified to include, exclude, and re-order modules based on the specific type of user information displayed and, optionally, based on a particular result that is specific to the user. For example, the template may include any two or more of the modules described herein, or it may include any three or more of the modules. The web page template and various styles of reports suitable for various types of personal medical information is exemplified herein, but these examples are not intended to be limiting on the invention.

The template includes a title module for displaying a physiological condition name and a physiological condition description. Optionally, the title module includes one or more condition-associated genes. The title module may be ordered anywhere on the template but is preferably in the first position of the template (i.e., at the top of the web page).

The template further includes a user information module for displaying genetic information of a user that is relevant to the physiological condition displayed in the title module. Optionally, the user information module contains genetic information of a user related to at least one of the condition-associated genes when condition-associated genes are displayed in the title module. The user information module may be ordered anywhere on the template but is preferably in the second position and/or abutting and being positioned below the title module.

The template further includes a test module for displaying intended use information about a test used to determine the genetic information. The test module may be ordered anywhere on the template. In one embodiment, the test module is immediately below and abutting the user information module, interpretation module, informational module, recommendation module, or combined user information/information module.

The template further includes an interpretation module for displaying interpretation information about an interpretation of the genetic information displayed in the user information module. The interpretation module may be ordered anywhere on the template. Preferably, the interpretation module is ordered below the user information module. In other embodiments, the interpretation module is immediately below and abutting the user information module or immediately below and abutting the test module which itself is immediately below and abutting the user information module.

The template further includes an informational module for displaying physiological condition information about the physiological condition displayed in the title module. The informational module may be ordered anywhere on the template. In one embodiment, the informational module is positioned below the title and user information modules. Optionally, the informational module is positioned below the interpretation module or the combined user information/interpretation module.

The template further includes a recommendation module for displaying recommendation information for user action based on the genetic information displayed in the user information module. The recommendation module may be ordered anywhere on the template. In one embodiment, the recommendation module is positioned below the interpretation module, the combined user information/interpretation module and/or the informational module.

The template further includes a combined user information/interpretation module for displaying a user's genetic information for a first trait displayed in the title module, or interpretation information about an interpretation of the genetic information, or both. In one embodiment, the template contains either the user information module together with the interpretation module, or only the combined user information/interpretation module. The user information module may be ordered anywhere on the template but is preferably in the second position and/or abutting and being positioned below the title module.

The template further includes an inheritance module for displaying the relationship between the user's genetic information for the physiological condition and genetic information for the physiological condition from one or more related individuals. In one embodiment, the genetic information for the one or more related individuals is contained within the results database. In another embodiment, the computing platform compares the user's genetic information for the physiological condition to the at least one related individual's genetic information for the physiological condition and displays an inheritance result in the inheritance module. In another embodiment, the inheritance module further comprises a user interface to accept a user input identifying at least one related individual for whom genetic information is stored in the results database. Related individuals may include any individual that is genetically related to the user such as parents, children, etc. The inheritance module may be ordered anywhere on the template but is preferably positioned below the user information module, interpretation module, combined user information/interpretation module, and/or the informational module.

The template further includes a non-genetic information module that contains a user interface for accepting user-entered information about one or more user physiological conditions. Optionally, the non-genetic information entered by the user is stored in the results database. The non-genetic information may be used by the computing platform when generating the display for the inheritance module.

The method for constructing a web page further includes accessing a medical database to obtain the physiological condition name, the physiological condition description, and/or the condition-associated genes and displaying the information in the first module on the web page. The medical condition database may be an electronic, proprietary database containing information related to physiological condition names, physiological condition descriptions, condition-associated genes, and the like. In addition, the method includes accessing a results database to obtain the user's genetic information for at least one of the condition-associated genes and displaying information about the at least one of the one or more condition-associated genes in the second module on the web page. The results database may be an electronic, proprietary database containing information related to genetic information for condition-associated genes. The method further includes accessing a test database to obtain the intended use information about the intended use of the test and displaying intended use information in the third module on the web page. The test database may be an electronic, proprietary database containing information related to intended-use information about a test that is used to assess an individual's DNA.

The method also includes: (i) accessing the medical database to obtain the interpretation information and displaying the interpretation in the interpretation module on the web page; (ii) accessing the medical database to obtain the medical condition information and displaying the information about the medical condition in the informational module on the web page; and (iii) accessing the medical database to obtain the recommendation information and displaying the recommendation in the recommendation module on the web page.

In one embodiment, the web page template facilitates user comprehension of the disclosed material. In one embodiment, the webpage template facilitates user comprehension in a manner that is clear and comprehensible to a lay-person who lacks or substantially lacks medical training and in the absence of a physician (or with minimal input from a physician). In one embodiment, viewing an educational module, such as a tutorial, facilitates user comprehension of the disclosed material. In one embodiment, user comprehension is at least 80% after reviewing the web page generated on the template. In another embodiment, user comprehension is at least 90%.

The web page template and associated methods described herein are not intended to be limiting on the content or format. For example, additional information modules may be included in the template and any module may be ordered in any position relative to any other module within the template, or may be absent. Furthermore, although the invention is exemplified by reference to the assessment, interpretation, and display of a user's genetic information obtained from its genomic DNA, personal medical information of other types and from other sources may be substituted or included. For example, the personal medical information may include information obtained from the analysis of a user's blood, RNA, proteome, and/or microbiome. Personal medical information may additionally include an individual's ethnicity, sex, family history, and the like.

Optionally, the template comprises a scientific detail module (which may be a second web page) containing information about the medical condition, one or more of the condition-associated genes, detailed genetic result information, detailed testing information, recommendation information, and/or any other related information not contained in the populated web page template.

These and other features of the disclosure will be described in more detail below with reference to the drawings.

### BRIEF DESCRIPTION OF THE DRAWINGS

The accompanying drawings, which are included as part of the present specification, illustrate embodiments and, together with the general description given above and the detailed description of the embodiment given below, serve to explain and teach the principles described herein.

FIGS. 1a and 1b are block diagrams illustrating a web page template 100 featuring a modular design, consistent with disclosed embodiments.

FIG. 1c is a system diagram illustrating an embodiment of a personal genome service platform.

FIGS. 2a-2c are block diagrams illustrating several versions of an exemplary module 140 (Title Module) for displaying a physiological condition name and a physiological condition description, consistent with disclosed embodiments.

FIGS. 3a-3e are block diagrams illustrating several versions of an exemplary module 145 (User Information Module) for displaying genetic information of a user, consistent with disclosed embodiments.

FIG. 4 is a block diagram illustrating an exemplary module 150 (Test Module) for displaying intended use information for a test, consistent with disclosed embodiments.

FIGS. 5a-5b are block diagrams illustrating several versions of an exemplary module 155 (Interpretation Module) for displaying an interpretation of the user's genetic information displayed in module 145, consistent with disclosed embodiments.

FIGS. 6a-6b are block diagrams illustrating several versions of an exemplary module 160 (Informational Module) for displaying intended use information for a test, consistent with disclosed embodiments.

FIGS. 7a-7c are block diagrams illustrating several versions of an exemplary module 165 (Recommendation Module) for recommendation information for user action, consistent with disclosed embodiments.

FIGS. 8a-8b are block diagrams illustrating several versions of an exemplary Combined User Information/Interpretation Module consistent with disclosed embodiments.

FIGS. 9a-9b are block diagrams illustrating several versions of an exemplary Inheritance Module consistent with disclosed embodiments.

FIG. 10 is a block diagram illustrating an exemplary Non-genetic Information Module for displaying intended use information for a test, consistent with disclosed embodiments.

FIG. 11 is a flowchart illustrating an exemplary method 800 for constructing a modular web page, consistent with disclosed embodiments.

FIGS. 12a-f are block diagrams illustrating an exemplary scientific detail module 190 for displaying information about a medical condition, one or more condition-associated genes, genetic results, testing data, and/or recommendations.

FIGS. 13a-f are block diagrams illustrating an exemplary educational module 185 for displaying a tutorial associated with a carrier status report, consistent with disclosed embodiments.

FIGS. 14a-c are block diagrams illustrating exemplary modules for displaying genetic information of a user and intended use information for a test, consistent with disclosed embodiments.

FIGS. 15a-c are block diagrams illustrating an exemplary grid system in connection with modules, consistent with disclosed embodiments.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the claims.

### DETAILED DESCRIPTION

### Terminology

The following terms are described to facilitate understanding of the embodiments disclosed herein.

By “physiological condition” is meant any health condition or status of a user. Physiological conditions include, but are not limited to, medical conditions, physical traits, physiological traits, and wellness conditions.

By “medical condition” is meant any disease or disorder that the user has, is diagnosed as having, is at risk for (i.e., predisposed to) developing or contracting, and/or has the potential to be passed on to offspring, whether or not the user has, or is at risk for developing, that medical condition (i.e., including users who are carriers of a genetically recessive disease). Medical conditions include diseases and disorders that have a genetic basis, epigenetic basis, or a combination of both genetic and epigenetic factors.

By “trait” is meant, collectively, physical traits, physiological traits, and wellness conditions.

By “physical trait” is meant any trait that has a defined phenotype and relates to the physical make-up of the user's body. Physical traits include, for example, hair color (light, dark, red, blond, brown, black, etc.), hair curliness, newborn hair amount, male pattern baldness, widow's peak (including presence or absence), unibrow (including presence or absence), finger length ratio, toe length ratio, bitter taste perception, sweet taste preferences, asparagus odor detection, photic sneeze, ear wax type, eye color, height, and skin color or tone, freckling, cheek dimples, cleft chin, earlobe type. Physical traits may be expressed by subjective/qualitative (e.g., color) or objective/quantitative (e.g., size, length, height, etc.) measures depending upon the specific physical trait of interest.

By “physiological trait” is meant any trait that has a defined phenotype and relates to a metabolic, enzymatic, or other physiological processes within the user's body. Physiological traits include, for example, enzymatic activity or expression levels and metabolic phenotypes associated the user's capacity to metabolize nutrients, drugs, or other substances such as lactose, caffeine, acetaminophen, alcohol, and other pharmaceuticals. Physiological traits also include measures of the absorption, distribution, metabolism, efficacy, excretion, and/or potential toxicity or other responses in the user's body of specific drugs, nutrients, and/or other substances. The results associated with physiological traits may be expressed as a binary outcome (e.g., presence or absence of intestinal lactase and/or lactose-intolerant or not), on an arbitrary scale, or as an absolute enzymatic expression or activity level.

By “wellness condition” is meant a measure of any metabolite, nutrient, toxin, or other endogenous molecule that may be causally or associatively linked to health, wellness, and/or disease. Wellness conditions include measures of those molecules that may be influenced by a user's behavior and diet, whether or not the wellness condition also is influence by the user's genetics. Wellness conditions include, for example, the user's level of hemoglobin, blood iron, blood cholesterol, blood lipids (e.g., HLD, LDL, VLDL, etc.), vitamin levels, level of caffeine or its metabolites (e.g., including an index of caffeine consumption), alcohol flush, muscle type, and lactose intolerance. It is recognized that there may be overlap between various traits (particularly physiological traits) and wellness conditions. Although no strict categorization is implied, certain of these physiological conditions may be presented in either format and their categorization may depend upon the specific result and/or recommendation presented. For example, metabolic enzyme levels (e.g., lactase levels) are indicative of a physiological trait whereas the resulting phenotype (e.g., lactose intolerance resulting from low or no intestinal lactase) may be considered to be a wellness condition.

“Condition-associated genes” are those genes that are causative, alone or in combination with other genes and/or epigenetic factors, that are known to, or suspected of, causing or otherwise linked to a physiological condition (e.g., a medical condition or any of its symptoms, a trait, and a wellness condition). For example, BLM is a condition-associated gene for Bloom Syndrome, a medical condition. Condition-associated genes may additionally include genes that are not considered causative but are correlated with a physiological condition and/or any of its symptoms, phenotypes, or manifestations.

A “user” is any person who is accessing personal medical and/or genetic information using the web page and/or template described herein.

“Genetic information” is not intended to be limiting to any particular type of information about the genome and is intended to include information such as the status and identity of point mutations, SNP alleles, haplotypes, insertions, deletions, translocations, karyotype including aneuploidy, and sequence information including DNA sequence information and the sequence of partial genes, genes, chromosomes, chromosome segments, and/or a user's whole genome.

“Test” refers to the specific analytical methodology used to determine a user's genetic information. Tests may be described broadly (i.e., tests for point mutations), with specific reference to the underlying methodology, or functionally (i.e., with reference to that which it is capable and/or incapable of detecting).

“Medical database” refers to one or more databases containing information about one or more physiological conditions, condition-associated genes, interpretations or other diagnostic information about the various genetic information results, and/or recommended user actions for each of the possible results.

“Results database” refers to one or more databases containing genetic and/or non-genetic information of one or more users. Non-genetic information may include, for example, the age, ethnicity (both self-reported or computationally defined), and various phenotypes of one or more users.

“Test database” refers to a database that contains information about, and descriptions of, the various tests used to generate the results that are contained in the results database.

### Embodiments

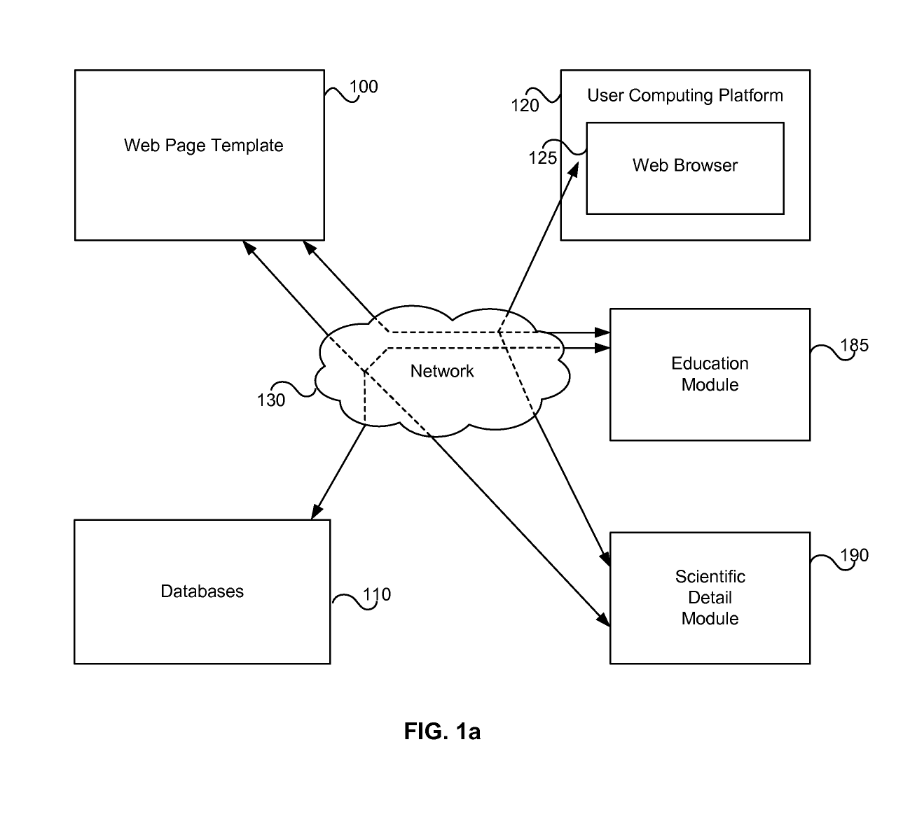

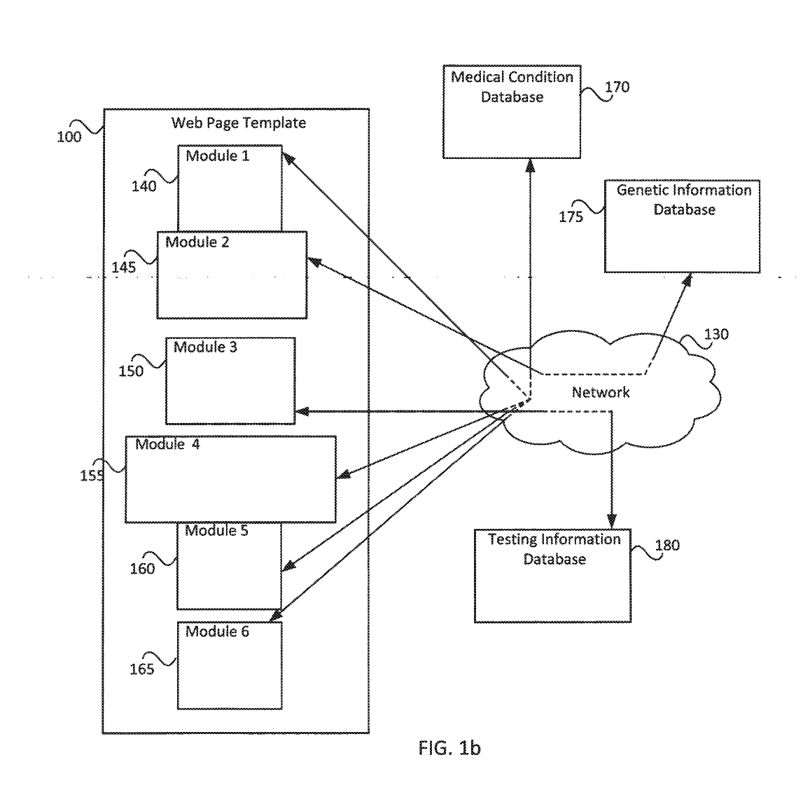

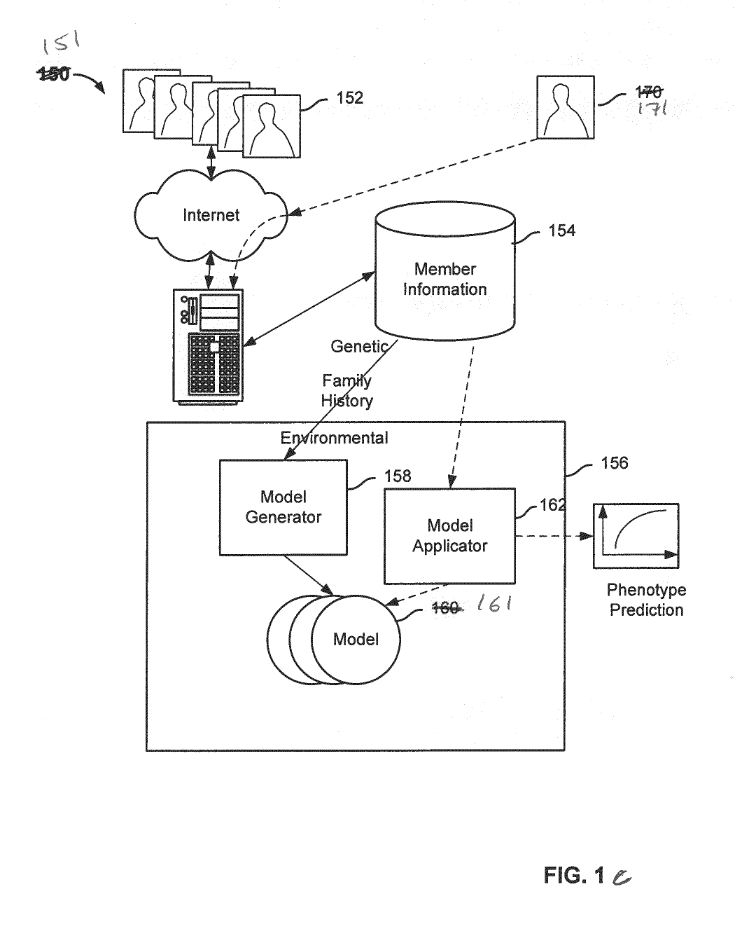

FIGS. 1a and 1b are block diagrams illustrating a web page template 100 featuring a modular design and resources associated with the template. Template 100 may include an arrangement of modules (e.g., reference numerals 140 through 165 in FIG. 1b) for displaying a variety of information to an individual who accesses a web page (based on a template 100) over a network 130—such as the Internet—via a web browser 125 on a user computing platform 120. Additional modules including, for example, additional informational modules, an educational module 185, and a scientific detail module 190, may be linked to a web page based on template 100 and accessible to web browser 125 on user computing platform 120, via network 130. Databases 110 may store the information displayed in the modules (including educational module 185 and scientific detail module 190) and enable the information to be accessed via network 130. Web page template 100, educational module 185, scientific detail module 190, user computing platform 120, and databases 110 may be interconnected by network 130. Although FIG. 1b illustrates a web page template having six modules, this figure is not intended to be limiting. A web page may be generated based on a template with any number or combination of modules disclosed herein.

As used herein, the term “web page” refers to an electronic document accessed via network 130 (such as the Internet) that is based on web page template 100. Additionally, a web page may include a document coded using one or more markup languages, such as HTML and/or XML, although the disclosed embodiments are not limited in scope in this respect. As explained more fully below, user computing platform 120 includes a processor (not shown) that may execute instructions, including those related to web browser 125. Executing web browser 125 may allow a user to access and view web pages over the Internet by causing, for example, a web page to be downloaded and displayed to the user via user computing platform 120 (e.g., a desktop computer, a table, a smart phone, etc.). A web page may be identified by a Uniform Resource Identifier (URI), such as a Uniform Resource Locator (URL), associated with the web page.

As illustrated in the paragraphs that follow, the modules may display information related to medical conditions, medical information, and genetic information personal to a user. Users are likely to have a greater interest and understanding of genetics-related concepts when they are presented with information (e.g., test results) that is personal to them. Displaying such information on a web page in accordance with the modular design described herein provides various advantages. For example, the modules may be arranged in a manner that facilitates user navigation through the displayed information and increases overall user comprehension. Similarly, the information provided within each module may be organized and presented in a manner that increases user comprehension of the displayed information. As will be discussed in the following paragraphs, the arrangement of the modules, and the organization of the information in each module, has been refined to increase user comprehension based on studies and testing information, such as user testing data, surveys, questionnaires, and the like. The disclosed embodiments are not limited to any particular configuration, arrangement, or organization of the modules and the information within each module. The arrangement or ordering of modules can be accomplished through their relative positions on a single web page or through how they are presented in a series of web pages, accessed sequentially through hyperlinks and/or other navigational tools present in the modules.

As shown in FIG. 1b, web page template 100 may include modules 140, 145, 150, 155, 160 and 165 in which information related to user genetic information and medical information is displayed. The displayed information may be obtained from medical database 170, genetic information database 175 and testing information database 180. Each of medical database 170, genetic information database 175 and testing information database 180 may optionally include more than one database and/or more than one location at which information is stored and/or accessed. Medical database 170 may include information related to medical condition names, medical condition descriptions, and condition-associated genes. Information may be obtained, for example, through medical and scientific literature. Genetic information database 175 may include information related to genetic information for condition-associated genes and non-genetic information for users (e.g., a user's age, ethnicity (both self-reported or computationally defined), and different phenotypes). Genetic information for a user may be obtained using any methodology appropriate to obtaining the specific information desired. For example, genetic information may include an analysis of individual gene mutations and/or whole genome sequencing. Testing information database 180 may include information related to intended-use information about a test that is used to assess an individual's DNA. As reflected in FIG. 1b, the various modules and databases may be interconnected by network 130. For example, modules 140, 155, 160 and 165 may be connected to medical condition database 170; module 145 may be connected to genetic information database 175; and module 150 may be connected to testing information database 180. The disclosed embodiments are not limited to any particular configuration of modules and databases.

In certain embodiments, a web page based on a template as described herein is made available or accessible to end users via a personal genome service platform such as described herein. A personal genome service (PGS) platform may include one or more computing systems and/or one or more databases that serve a plurality of user computing platforms. In some implementations, the web pages described herein are considered part of the personal genome service platform. In some implementations, the web pages and the personal genome service platform share resources such as one or more databases (or portions thereof) and one or more computational engines for, e.g., predicting user traits or conditions from user genetic information.

FIG. 1c is a system diagram illustrating an embodiment of a personal genome service platform or system 151 such as the platform implemented by 23andMe, Inc. It is designed and/or configured to collect information from its members. In some implementations, members 152 of the service log on through their computing platforms to the website operated by the personal genome service provider to fill out survey information about their family history (e.g., disease history or health or medical condition of one or more relatives), environment (e.g., smoking habits, diet, exposure to toxins, etc.), as well as phenotype data (e.g., other diseases and/or health or medical conditions). The family history and environmental information is stored in one or more databases 154 such as a results database and/or a genetic information database as described above. Nucleic acid samples (e.g., saliva, blood, etc.) are collected from the members and analyzed using a nucleic acid microarray, a nucleic acid sequencer, or other appropriate techniques. The genetic information is also stored in a database that may be the same as or separate from database 154. In various embodiments, the genetic information includes DNA sequences, gene sequences, genome sequences, chromosomes, chromosome segments, single-nucleotide polymorphisms (SNPs), mutations, insertions, deletions, translocations, haplotypes, sequence information and/or other representations of the members' genes, DNA sequences, genome, chromosomes, or sequence information.

In certain embodiments, a phenotype prediction engine 156 is used to predict a phenotype given certain information about an individual. Phenotypes that can be predicted by the prediction engine include disease as well as non-disease related traits, physiological traits, and/or physical traits, such as height, weight, body mass index (BMI), cholesterol levels, etc. The types of predictions include but are not limited to the probability of a disease or health or medical condition occurring over the course of an individual's lifetime, the probability of a disease or health or medical condition occurring within a specific time frame, the probability that the individual currently has the disease or health or medical condition, estimates of the value of a quantitative measurement, or estimates of the distribution of likely measurements.

In the embodiment of FIG. 1c, the engine includes a model generator 158 that is configured to use genetic, family history, and/or environmental information about members from the database and generate models 161 for predicting the various phenotypes. In some embodiments, the models are stored in a database or other appropriate storage location.

Once the models are generated, a member 171 (who may or may not be a part of the cohort used to form the models) can initiate a request via the web interface (structured as described elsewhere herein) to make a prediction about a certain phenotype (such as a particular disease or health or medical condition). The request is sent, in this case via the webserver, to the phenotype prediction engine, which invokes a model applicator 162. The model applicator retrieves genetic, family history, and environmental information about the requesting member from the database, applies the information to the appropriate model, and outputs a phenotype prediction. The phenotype prediction engine, the model generators and applicators, and the models themselves may be implemented in hardware and software as described above with reference to the modules.

Any of the computing platforms described herein, whether controlled by end users or by an entity serving web pages or other information in, e.g., a personal genome service platform, can be implemented as software components executing on one or more general purpose processors, as hardware such as programmable logic devices and/or Application Specific Integrated Circuits designed to perform certain functions or a combination thereof. In some embodiments, code executed during operation of modules can be embodied by a form of software elements which can be stored in a nonvolatile storage medium (such as optical disk, flash storage device, mobile hard disk, etc.), including a number of instructions for making a computer device (such as personal computers, servers, network equipment, etc.). The modules and other computational structures described herein may be implemented on a single device or distributed across multiple devices. The functions of the modules may be merged into one another or further split into multiple sub-modules.

Each module may be implemented as an organized collection of computer data and instructions. In certain embodiments, a module and a template can each be viewed as a form of application software that interfaces with a user and with system software. System software typically interfaces with computer hardware, typically implemented as one or more processors (e.g., CPUs or ASICs as mentioned) and associated memory. In certain embodiments, the system software includes operating system software and/or firmware, as well as any middleware and drivers installed in the system. The system software provides basic non-task-specific functions of the computer. In contrast, the modules and other application software are used to accomplish specific tasks. Each native instruction for a module is stored in a memory device and is represented by a numeric value.

At one level a module is implemented as a set of commands prepared by the programmer/developer. However, the module software that can be executed by the computer hardware is executable code committed to memory using “machine codes” selected from the specific machine language instruction set, or “native instructions,” designed into the hardware processor. The machine language instruction set, or native instruction set, is known to, and essentially built into, the hardware processor(s). This is the “language” by which the system and application software communicates with the hardware processors. Each native instruction is a discrete code that is recognized by the processing architecture and that can specify particular registers for arithmetic, addressing, or control functions; particular memory locations or offsets; and particular addressing modes used to interpret operands. More complex operations are built up by combining these simple native instructions, which are executed sequentially, or as otherwise directed by control flow instructions.

The inter-relationship between the executable software instructions and the hardware processor is structural. In other words, the instructions per se are a series of symbols or numeric values. They do not intrinsically convey any information. It is the processor, which by design was preconfigured to interpret the symbols/numeric values, which imparts meaning to the instructions.

A module may be implemented as a standalone piece of code that provides specific and tightly coupled functionality. In various embodiments, a module (i) includes code and data to implement the described functionality, (ii) has an interface that lets users access its functionality in a consistent manner, (iii) can interact with another module that expects its interface, and (iv) can be deployed as a single unit. For example, dapper.net encapsulates database access. It may have an Application Programming Interface (API) to access its functionality. In some implementations, a module is useable in a modular programming paradigm in which software is composed of separate, interchangeable components called modules. Modular programming breaks down program functions into modules, each of which accomplishes one function and contains code necessary to accomplish this.

A template may be viewed as a page structure or format for a web page. It may be used repeatedly. In addition to the choice and arrangement of modules, a template may include, for example, a horizontal header, followed by a two column layout (A Column=80% width+B Column=20% width) finished with a horizontal footer. Beyond the definitions provided in the template, a user or developer has considerable latitude in customizing a web page. Thus, for example, a developer can insert additional objects (e.g., a search bar, a news feed, a table, etc.), not specified in the template, within a web page.

Not all potential users of web templates have the willingness and ability to design a system for their needs. Additionally, some may wish to use the web but have limited or no technical proficiency. For these reasons, one may use web templates specifically for reuse by non-technical people, although web template reusability is also important for even highly skilled and technically experienced developers.

Programming languages such as Perl, Ruby, C, and Java support template processing either natively, or through add-on libraries and modules. JavaServer Pages (JSP), PHP, and Active Server Pages (ASP with VBScript, Jscript, or other languages) are examples, themselves, of web template engines. These technologies are typically used in server-side templating systems, but could be adapted for use on an “edge-side” proxy or for static page generation.

A web browser and web server are implemented in a client-server architecture; often a web cache is also used to improve performance. The generation of web pages through templates and substitution (insertion) of information in modules may be accomplished using any number implementations, including by using:
Server-side—run-time substitution happens on the web server
Client-side—run-time substitution happens in the web browser
Edge-side—run-time substitution happens on a proxy between web server and browser
Outside server—static web pages are produced offline and uploaded to the web server; no run-time substitution
Distributed—run-time substitution happens on multiple servers

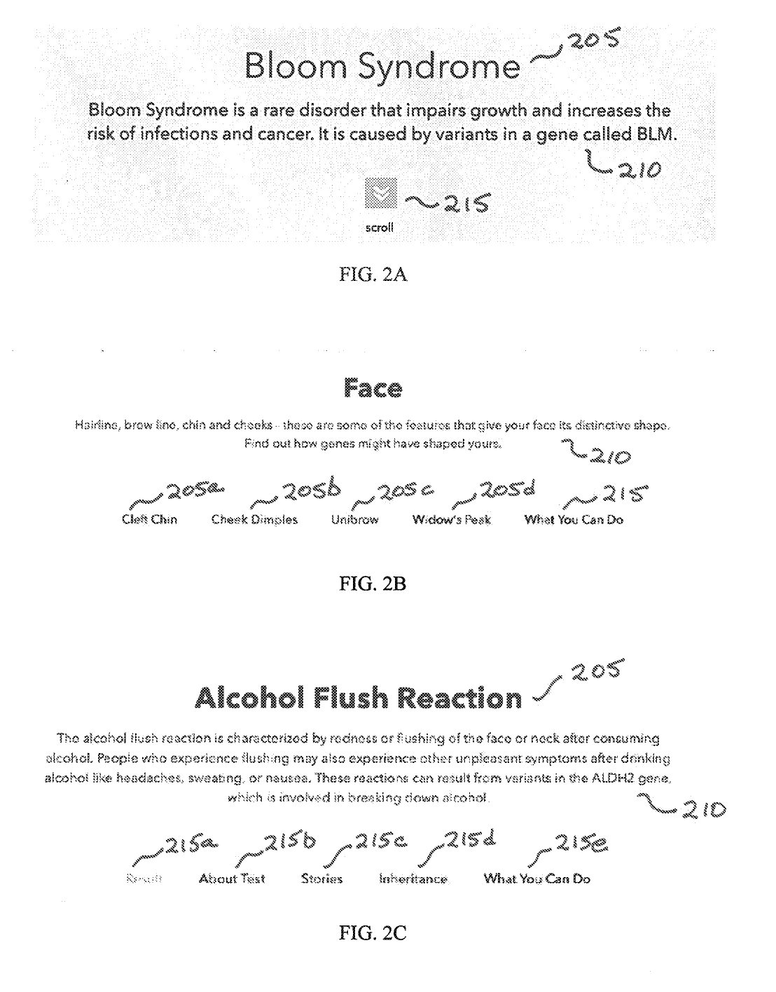

Different configurations and arrangements of the modules in FIG. 1b are described in greater detail in connection with FIGS. 2-7, below. For ease of illustration, the modules illustrated in FIGS. 2-7 are described with respect to a particular medical condition known as “Bloom Syndrome” and a user identified as “Jamie.” Bloom Syndrome is a medical condition having a genetic linkage or predisposition and is used for exemplary purposes only. “Jamie” and her demographic information are fictitious and used herein to merely to aid in understanding the structure of the invention. It is preferred that the web page and associated results is personalized for each actual user. It is understood that the various modules may be appropriately modified to deliver information about any physiological condition and it is not intended that the modules exemplified below are limited to the particular physiological condition recited.

As shown in FIGS. 2-7, each module may include various configurations of graphical and/or text elements. Graphical elements include icons (e.g., icons of varying sizes representing a recurring element or illustrating a novel concept), visual representations of text (e.g., DNA, statistical information, etc.), navigational tools (e.g., scroll bars, buttons, etc.), and the like. Text elements include headings and subheadings, subtext for graphical elements, bullet lists, hyperlinks, hover links, and the like. The disclosed embodiments are not limited to any particular configuration or arrangement of graphical and text elements. Additionally, text elements may have various associated parameters, such as font size, font color, font style, and the like. The disclosed embodiments are not limited to any particular set of parameters.

When executing, a module displays, via an associated web page, graphical and/or textual elements in the manner discussed below. Each module has various features and feature options as described. Each of these features is displayed or otherwise implemented as the module executes. Execution occurs when the web page is rendered in response to a triggering event such as a user selecting a hyperlink for the web page, launching an application associated with a PGS, etc. Additionally, a module may have code for receiving user input via a user interface presented for the module. For example, the user may type in text or interact with a graphical element. In response to receiving the user input, the module may modify the presented content.

First Module—Title Module

FIGS. 2a-2c are block diagrams illustrating exemplary title modules which may be presented as module 140 for displaying a physiological condition name and a physiological condition description (hereinafter referred to as the “First Module” or the “Title Module”). The Title Module may be displayed at the top of the web page; doing so may be advantageous to capturing the user's attention and alerting the user to the displayed medical condition of interest.

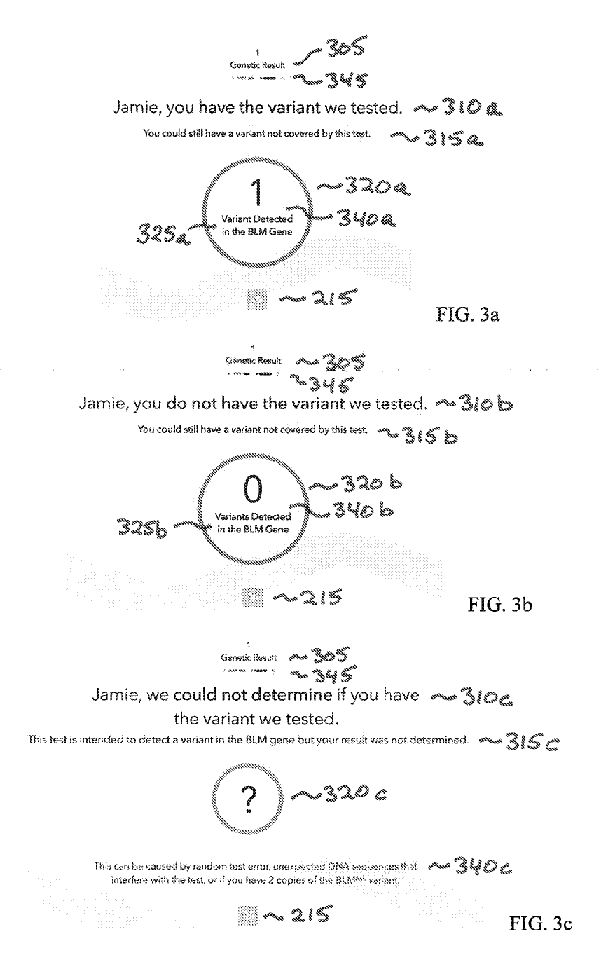

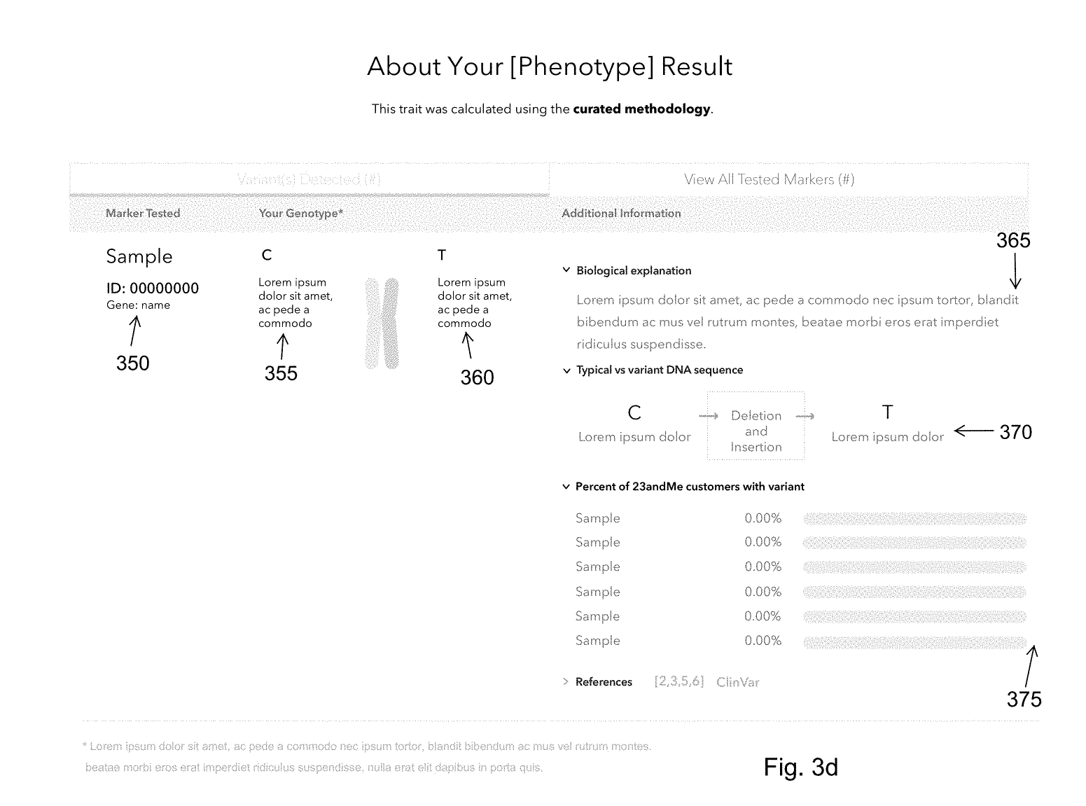

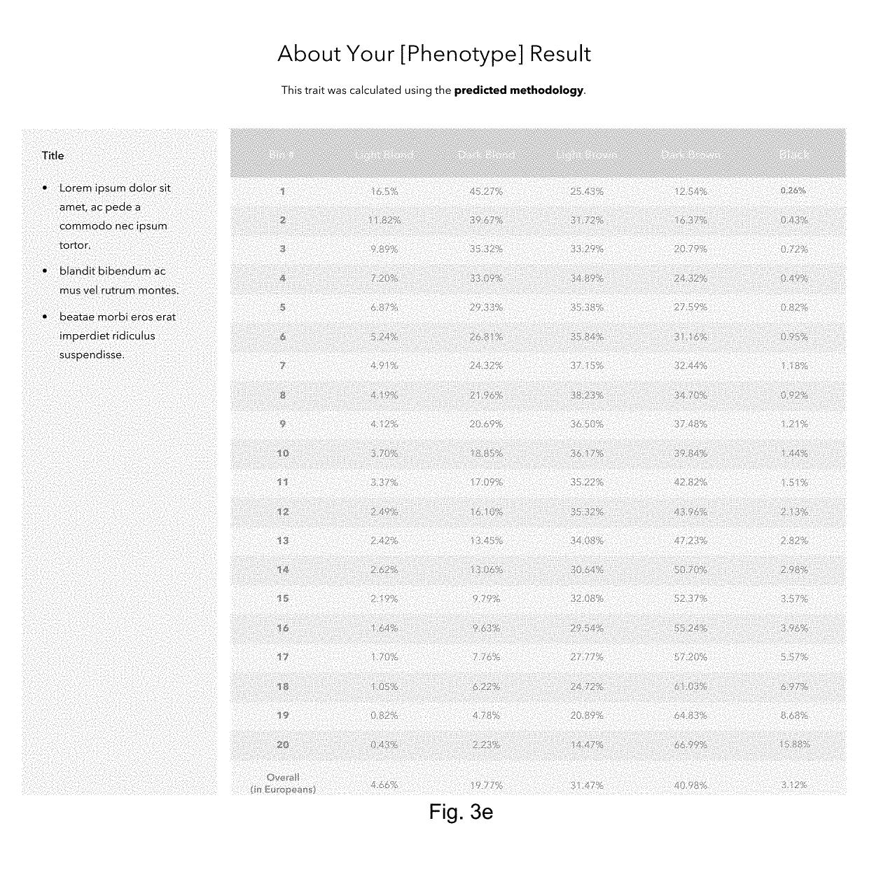

As shown in FIG. 2a and exemplified for a medical condition, the Title Module may include text elements 205 identifying a medical condition name (“Bloom Syndrome”) and 210 providing a brief description of the medical condition (“Bloom Syndrome is a rare genetic disorder that impairs growth and increases the risk of infections and cancer.”). Text element 210 may additionally describe one or more genes associated with the medical condition (“A person must have two variants in the BLM gene in order to have the condition.”). Further information on the medical condition may be provided in other modules included in web page template 100, as will be described in connection with FIGS. 3-7, below.

The Title Module also may include additional elements, such as a navigational element 215 (“Overview”) and a vertical navigational bar (not pictured). Navigational element 215 may appear in a font (e.g., blue, bolded font) that distinguishes the displayed text from text elements 205 and 210. A user clicking on navigational element 215 may cause the web page to center on text elements 205 and 210, directing the user's attention to the information provided in those text elements. Alternatively, a user clicking the navigation element 215 may cause the web page to center on another module presented elsewhere (e.g., lower down) on the web page. For example, a user clicking on the navigation element may cause the web page to center on the module presented immediately below the module in which the navigation element is provided. The navigational bar (not pictured) enables the user to quickly scroll to another module, for example, to the module described in connection with FIG. 3, below. Modules 145, 150, 155, 160 and 165 may also include a navigational bar. Using graphical elements in conjunction with text elements facilitates user comprehension of the information displayed on the web page. Graphical elements may also provide enhanced navigation through the modules and various elements on the web page.

As reflected in FIG. 2, text elements 205 and 210 are displayed using different formatting options. In particular, the medical condition name (text element 205) appears in a larger font size and is centered above the medical condition description (text element 210). Displaying text elements 205 and 210 in this manner may result in increased user comprehension of the displayed information. The disclosed embodiments are not limited to any particular configuration of formatting options.

FIG. 2b is a block diagram illustrating an alternative example of a Title Module that is exemplified by a plurality of physical traits. Optionally, the title of module makes reference to the plurality of traits to which the web page is directed. In this case, the title 200 refers to the “face” which itself is not a physiological condition. The plurality of traits to which the web page is directed are identified individually as elements 205a, 205b, 205c, and 205d; “cleft chin,” “cheek dimples”, “unibrow,” and “widow's peak,” respectively. The title module contains a brief description 210 relevant to the plurality of traits to aid in orienting the user as to the information to be presented on the web page. Optionally, a navigation element is embedded within each of these trait identification elements 205a-205d such that the web page navigates to the web page module that provides information about that trait; thereby allowing the user to view the information out of the presented order. Optionally, the Title Module provides one or more additional navigation elements 215.

FIG. 2c is a block diagram illustrating an alternative example of a Title Module. In this example, information on a single physiological condition 205 is indicated as being provided on the web page. The Title Module contains a plurality of navigation elements that allow the web page to center, or otherwise be directed, to other modules as specified by a user.

Second Module—User Information Module

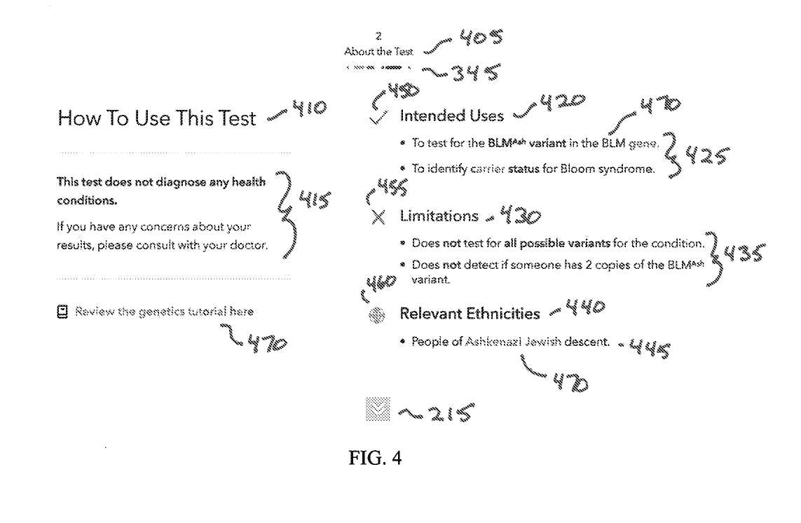

FIG. 3a is a block diagram illustrating an exemplary User Information module which may be presented as module 145 for displaying genetic information of a user (hereinafter referred to as the “Second Module” or the “User Information Module”). The User Information Module may include navigational element 305a (“Genetic Result”), indicating to the user that the User Information Module relates to the user's genetic information. A user clicking on navigational element 305a may cause the web page to center on text elements 310 and 315, directing the user's attention to the information provided in those text elements. The Second Module may also include navigational elements 305b (“About Test”), 305c (“Explanation”), 305d (“About Bloom”), and/or 305e (“What You Can Do”). Clicking on one of navigational elements 305b-e may cause the web page to scroll or jump to the module associated with the respective navigational element 305b-e. For example, navigational elements 305b, 305c, 305d, and 305e may be associated with the modules described in connection with FIGS. 4, 5, 6, and 7, respectively. Alternatively, navigational elements 305b-e may appear (in a manner similar to navigational element 305a) in each of the modules described in connection with FIGS. 4-7. In addition, the User Information Module may be displayed adjacent to and/or below the Title Module.

As shown in FIG. 3a-3c, the User Information Module may display text elements 310 indicating whether or not the user (Jamie) has a variant of the one or more genes associated with the medical condition (Bloom Syndrome). In the displayed example, the User Information Module indicates that Jamie does not have the variant tested. Alternatively, if Jamie did have the tested variant, text element 310 may display the statement “Jamie, you have the variant we tested.” Similarly, if it is unknown whether or not Jamie has the variant text element 310 may display the statement “Jamie, we could not determine if you have the variant we tested.” Text elements 310 may optionally be displayed using a font or font style that emphasizes certain words or a phrase indicating the user's genetic information to quickly inform the user as to whether or not the user has the variant. In one embodiment, for example, this could be achieved by bolding the phrases “have the variant,” “do not have the variant” (or simply by bolding “not”), and “could not determine.” Text element 310 may additionally include corresponding subtext element 315 that provides additional clarification. For example, whether or not Jamie has the tested variant, Jamie could still have a variant that is not covered by the test, as indicated by subtext element 315. The subtext element may be displayed using a smaller font size to indicate the presentation of clarifying information to the user.

The User Information Module also may include graphical element 320 in conjunction with text element 310. Graphical element 320 enables the user to visually comprehend his or her genetic information as provided in the User Information Module. Graphical elements may include a variety of geometric shapes—such as circles, ovals, capsules, and polygons, as well as triangles, squares, pentagons, hexagons, heptagons, octagons, nonagons, and decagons—and styles and colors. In some embodiments, graphical elements are displayed in a color different from the text color used within the module. As reflected in FIG. 3a-3c, to display the user's genetic information, graphical element 320 may include a numeral or symbol (“0,” “1” or “?”), representing the number of mutations identified in the gene, enclosed within a circle, where the numeral or symbol and the circle are displayed using different colors. Further, the Second Module may include clarifying text 325 positioned inside graphical element 320 to help the user understand the significance of graphical element 320. The disclosed embodiments are not limited to any particular configuration or arrangement of graphical elements. Preferably, the graphical element including the number of variants comprise at least 20%, 25%, 30%, 35%, 40%, 45%, 50%, or more of the area of the User Information Module. To further capture the user's attention and help provide visual cues as to the informational content, the User Information Module may include graphical element 330 depicting a DNA-related pattern displayed in the background. This style of presentation is useful for displaying genetic information that is monogenic or polygenic and has discrete mutations or variations that cause or are linked to the physiological condition of interest. However, this presentation does not necessarily result in a high user comprehension, or is appropriate, for polygenic information that is linked to medical conditions, physical or physiological traits, or wellness conditions that are continuous, subjective, or qualitative in nature (e.g., hair color, eye color, and skin tone), and/or wherein multiple genes or variants contribute differently to that trait.

FIG. 3b-3c provides an illustration of an optional display format for the User Information Module which may be used in combination with or instead of the display format shown in FIG. 3a.

Optionally, the User Information Module may provide additional detailed information regarding the user's genetic information. For example, the User Information Module may contain graphical, textual, or a combination of graphical and textual elements that identify the normal or most prevalent condition at the site of a point mutation (variant) of interest along with an indication of the user's actual status for that site. The User Information Module may contain a section having some or all of the elements illustrated in FIG. 3d. FIG. 3d illustrates an example in which the normal (non-mutated) genetic sequence has a cytosine (“C”) 355 at the position of interest and the user has a thymine (“T”) 360 indicating the presence of a variant. The interpretation may be reiterated and/or differently presented in a simplified graphical element 370 to aid in user comprehension. Optionally, the User Information Module further includes a biological explanation 365 of the importance or other information about the results presented. Optionally, the User Information Module also contains population information 375 which illustrates the prevalence of the user's genetic information, the normal condition, or both in a relevant population of individuals. Interpretation of this result may be provided, additionally or in the alternative, in the Fourth or Seventh Module.

For physiological conditions that are polygenic and/or continuous in nature, it may be beneficial to present more detailed genetic information. This information typically will be presented in tabular form. As exemplified in FIG. 3e, the User Information Module may provide a table displaying results from the various genes and/or variants and their relative contribution to, or effect on the physiological trait of interest.

Third Module—Test Module

FIG. 4a is a block diagram illustrating an exemplary test module which may be presented as module 150 for displaying intended use information for a test (hereinafter referred to as the “Third Module” or the “Test Module”). The Test Module may include a title “How To Use This Test” (indicated by text element 410) to indicate to the user that the Test Module provides information regarding the test used to determine the user's genetic information (displayed in the Second Module).

The Test Module may organize the test information into several sections to facilitate user comprehension of the test information. As shown in FIG. 4a, a section with the bolded heading “How To Use This Test” (text element 410) includes subtext 415 informing the user that the test does not diagnose health conditions and directing the user to consult with his or her healthcare provider. The Test Module further may include sections entitled “Intended Uses” (text element 420), “Limitations” (text element 430) and “Relevant Ethnicities for this Test” (text element 440) to provide the user with additional detail as to the testing information. Positioned below the heading “Intended Uses” is a bullet list (text element 425) describing how the user should understand the purposes of the test, i.e., to check for the BLM variant in the user's BLM gene and identify whether the user is a carrier for Bloom Syndrome. Similarly, a bullet list (text element 435) describing how the user should understand the limitations of the test (i.e., the test does not check for all possible BLM variants, does not identify carriers of variants not covered by the test, and specifically does not detect whether the user has two copies of the BLM variant) appears below the heading “Limitations.” The Test Module also may provide a bullet list (text element 445) identifying the relevant ethnicities (i.e., Ashkenazi Jews 470) below the “Relevant Ethnicities for this Test” heading 440, or any other relevant demographic or personal information including, but not limited to, age, gender, weight, body mass index, or result from another medical laboratory or diagnostic test (e.g., cholesterol level, blood pressure, etc.).

The use of different formatting options and the inclusion of graphical text elements may assist the user in comprehending the provided testing information. For example, text element 345 appears directly below the title 405 which may be displayed in a larger font size relative to other text elements in this module) to draw the user's attention to information the user should consider (text element 410) prior to considering more specific, detailed testing information (text elements 420, 430 and 440). That the test does or does not diagnose health conditions (text element 415) is indicated using bold-style font to alert the user accordingly. In addition, each of the more specific sections 415, 425, 435 and 445 have associated with them illustrative graphical icons 450, 455 and 460 appearing next to the respective titles. Those icons attract the user's attention and inform the user's expectations as to the contents of the corresponding sections, before the user even begins reading the informational points reflected in text elements 420, 430 and 440.

The Test Module further may include text hyperlinks (indicated by reference numeral 470) and/or navigation elements 215. The text hyperlinks may appear in a contrasting font color, size, and/or style to alert the user to the presence of hyperlinks leading to additional information. Additionally, as shown in FIG. 4a, certain words or phrases (e.g., “BLM variant,” “all possible variants” and “Ashkenazi Jewish”) may be emphasized by appearing in bolded font to contrast the words or phrases from the unbolded font of the surrounding text. The use of hyperlinks and contrasting bolded font further increases user comprehension by quickly highlighting key information for the user and enabling the user to access additional, pertinent information, as needed or desired. In addition, using hyperlinks provides the further benefit of reducing “clutter” and increasing the amount of negative space on the web page.

Fourth Module—Interpretation Module

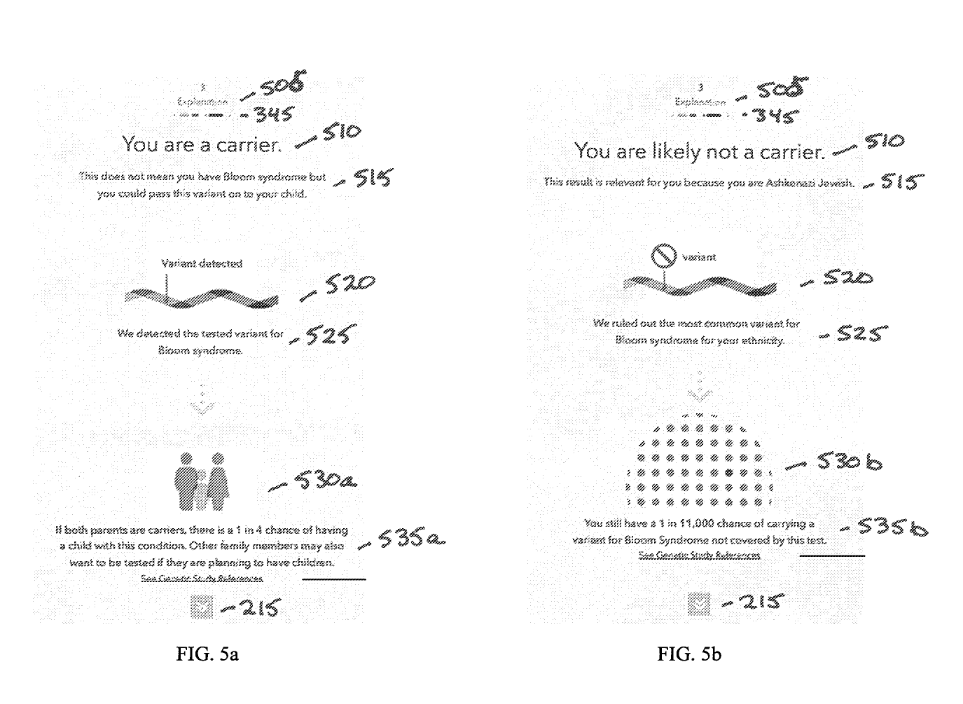

FIG. 5 is a block diagram illustrating an exemplary Interpretation Module which may be presented as module 155 for displaying an interpretation of the user's genetic information displayed in the User Information Module (hereinafter referred to as the “Fourth Module” or the “Interpretation Module”). The Interpretation Module may be displayed below the User Information Module.

The Interpretation Module may include a section title 505 indicating the content of the module, and a text element 510 reflecting the user (Jamie)'s carrier status and interpretation of the user's genetic information displayed in the User Information Module (e.g., as to the tested variant in the BLM gene). For example, if Jamie is determined to not be a carrier of the variant, the Fourth Module may include the statement “You are likely not a carrier,” as shown in FIG. 5. Alternatively, if Jamie is determined to be a carrier of the variant, text element 510 may include the statement “You are likely a carrier.” Similarly, if it is unknown whether or not Jamie is a carrier, text element 510 may instead include the statement “We could not determine your carrier status.”

The Interpretation Module may include subtext 515 providing additional explanation and/or clarification as to Jamie's determined carrier status based on, for example, the nature of the medical condition and Jamie's ethnicity. As shown in FIG. 5, for example, if Jamie is unlikely to be a carrier (or if Jamie's carrier status is unknown), the import of that determination may vary depending on whether Jamie is full, partial, or not at all Ashkenazi Jewish. Alternatively, if Jamie is determined to be a carrier, Jamie does not necessarily have Bloom Syndrome but could pass the variant to a child. The subtext 515 elements may be displayed using a smaller font size to indicate the presentation of clarifying information to the user.

The Interpretation Module also may include graphical elements that provide users with visual cues to facilitate comprehension of the displayed textual information. As shown in FIG. 5, the Fourth Module may include graphical element 520 depicting Jamie's carrier status (in the example provided, Jamie is likely not a carrier of the tested variant) in conjunction with a brief explanation indicated by text element 525 (in the example provided, the explanation summarizes Jamie's carrier status and provides the import of the determination based on Jamie's ethnicity). Graphical element 520 and text element 525 may vary in the case where Jamie is determined to be a carrier or where Jamie's carrier status is unknown. The disclosed embodiments are not limited to any particular configuration or arrangement of graphical elements.

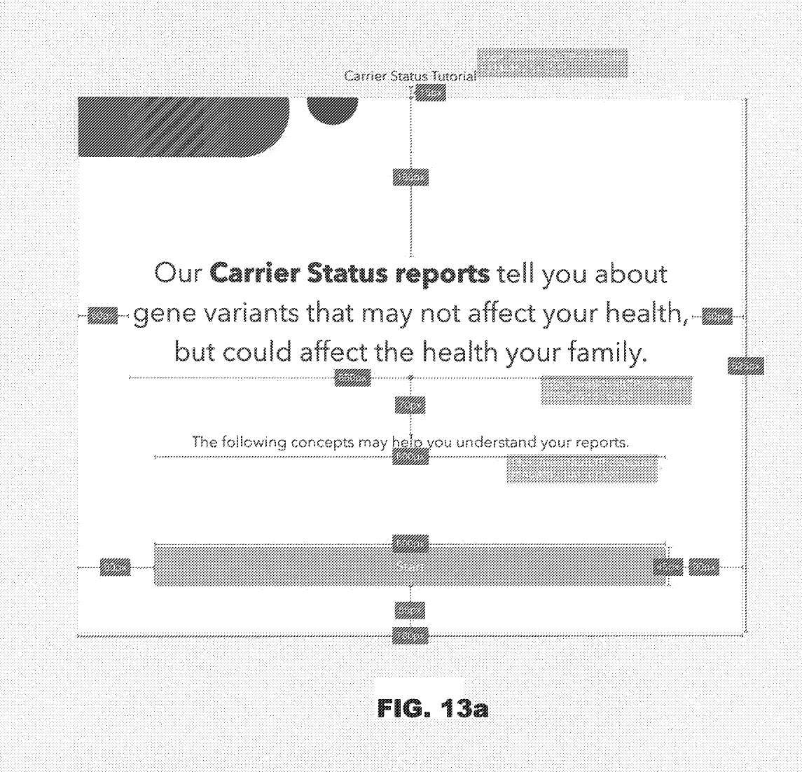

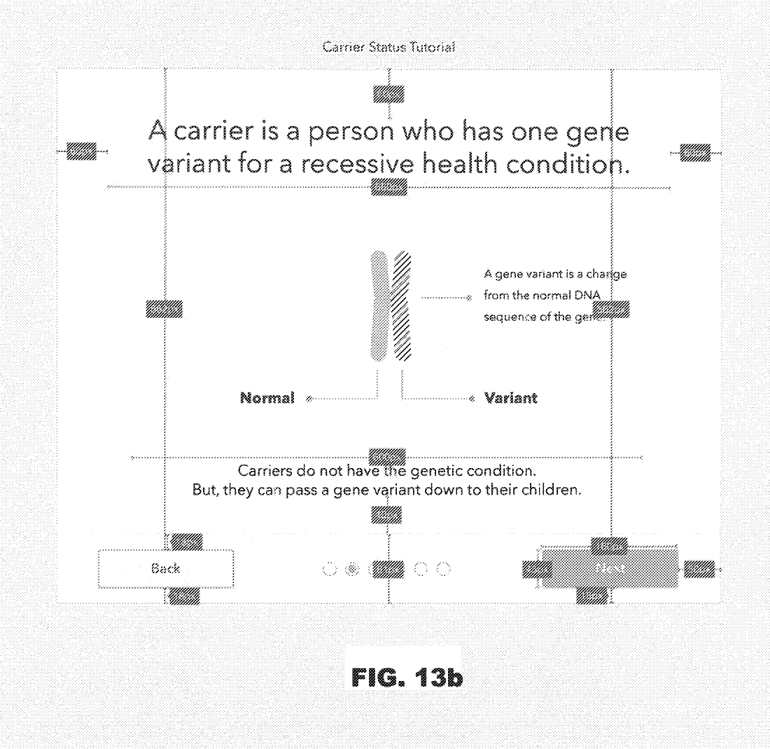

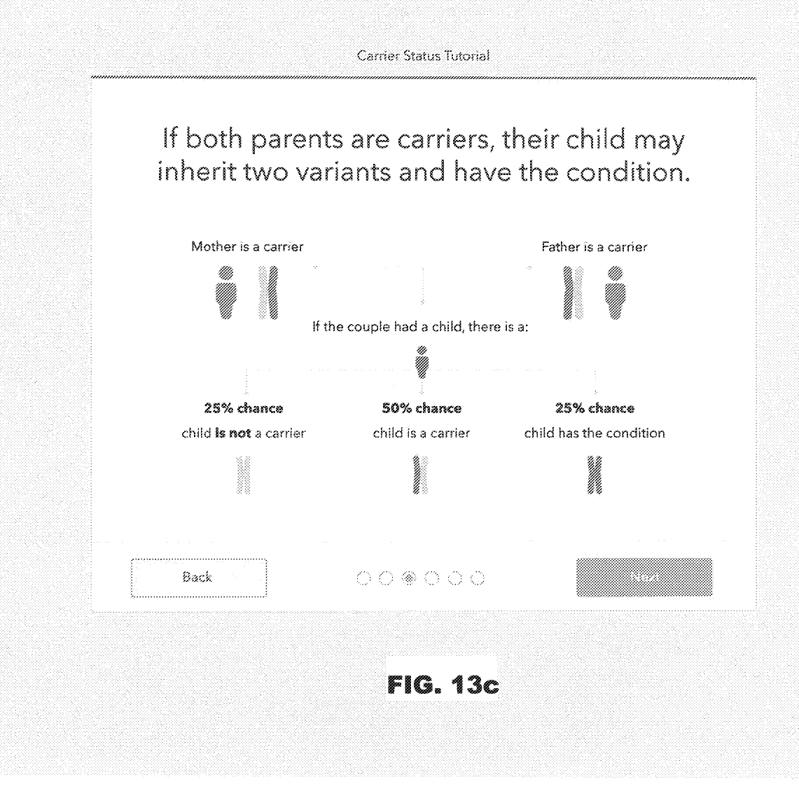

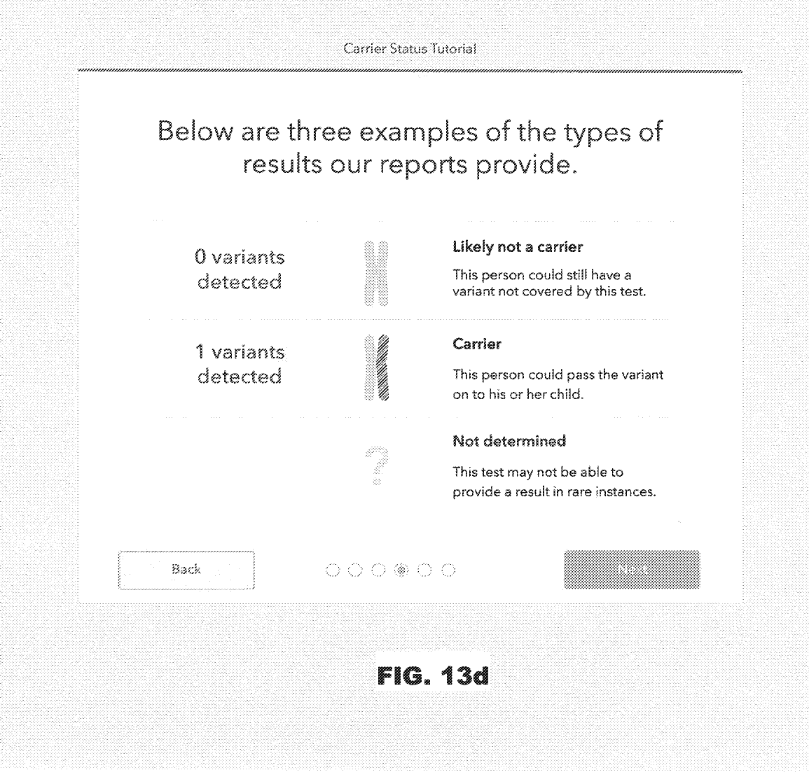

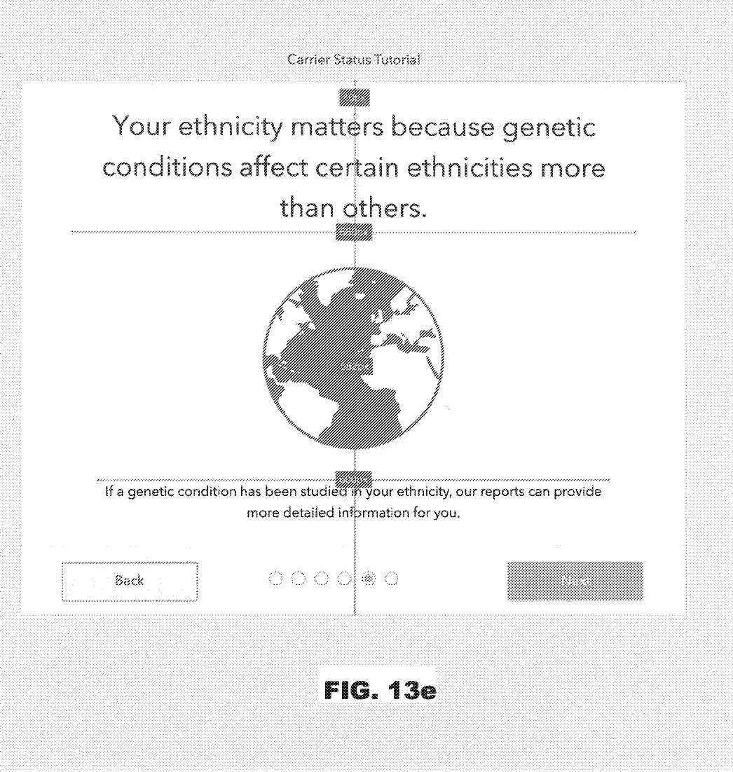

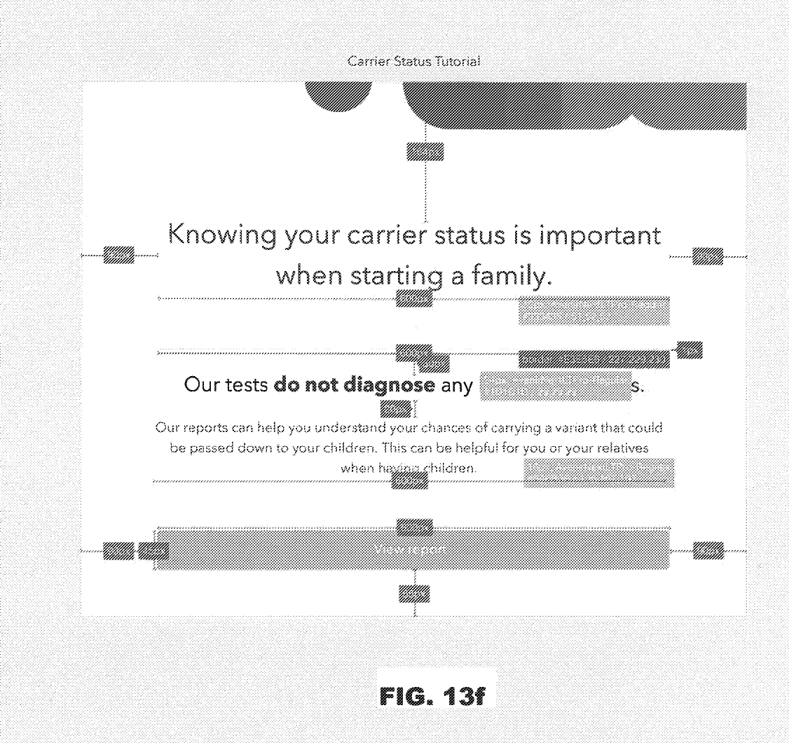

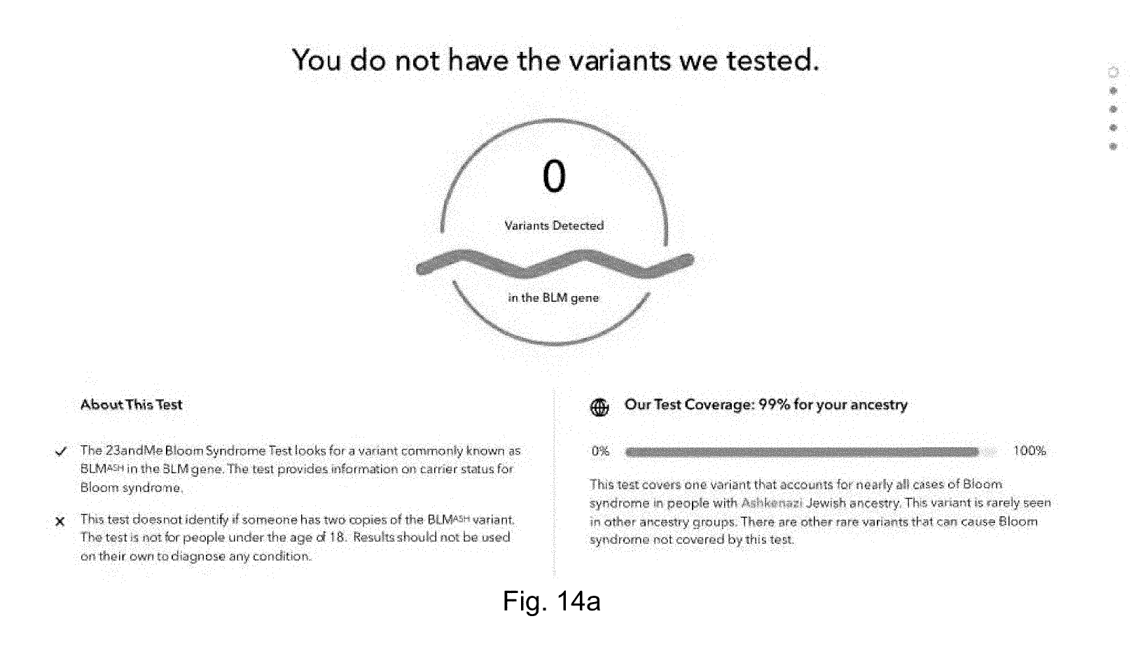

In addition to graphical element 520 and text element 525, the Interpretation Module may include graphical element 530 and text elements 535 to further explain the significance of the information displayed in this module. The relationship of this further explanation to Jamie's carrier status may be signaled to the user using a linking icon, such as an arrow or other graphic (not pictured). In one example, graphical element 530b and text elements 535b illustrate and explain the odds of being a carrier of a variant of Bloom Syndrome (in the example provided, odds of 1 in 11,000), depending on Jamie's ethnicity (or other demographic information). In another example, graphical element 530a and text elements 535a illustrate and explain the likelihood of having an affected offspring. Text element 525 may appear in larger and bolded font (relative to text element 535) to capture the user's attention and quickly summarize the informational content of graphical element 520 and text element 525. Graphical element 520 and 530, and text elements 525 and 535 may vary in the case where the user is determined to be a carrier or where user's carrier status is unknown. The Interpretation Module may also include a hyperlink element 540. Preferably, the hyperlink directs the user to a separate module or web page containing additional information relevant to the physiological condition and/or the interpretation presented in this module to inform the user that additional, detailed information is available through various sources (e.g., a “Scientific Details” module). An example of additional, detailed information for user consideration is provided in scientific detail module 190 depicted in FIGS. 13a-f. The use of hyperlinks in this manner reduces the amount of text and visuals presented to the user, therefore reducing the risk that the user will be “overloaded” or overwhelmed by too much information, thereby increasing user comprehension of the critical information.

Fifth Module—Informational Module

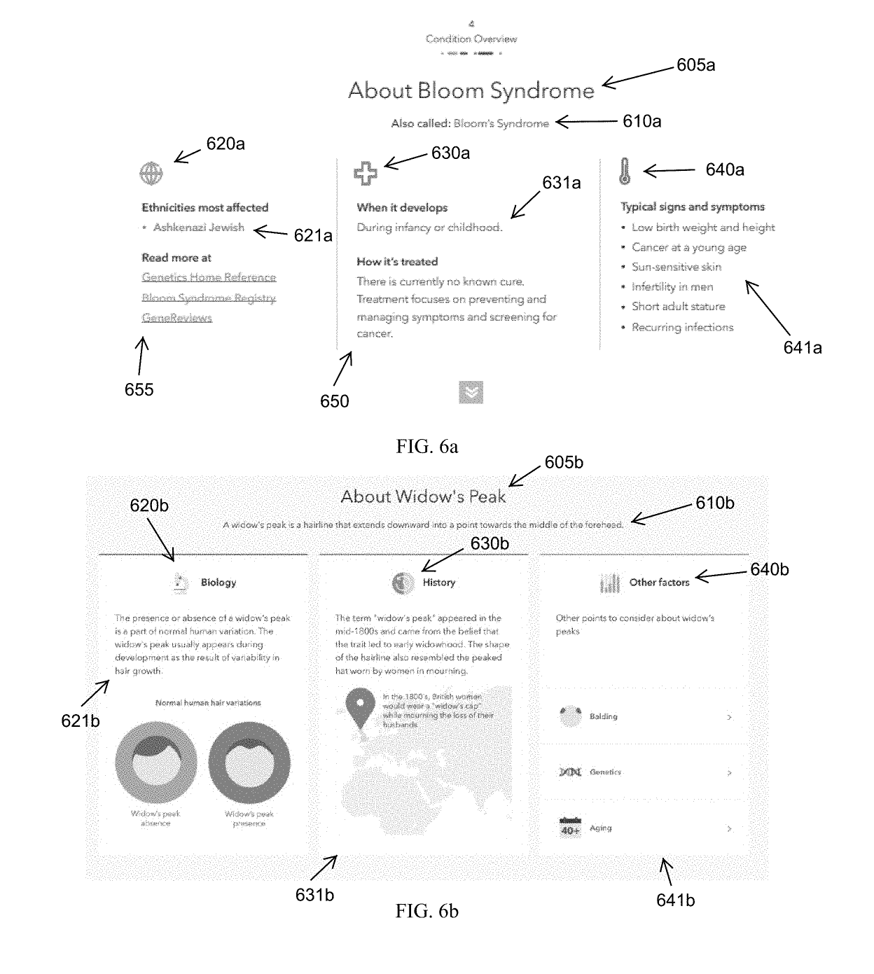

FIG. 6 provides block diagrams illustrating exemplary informational modules that may be presented as module 160 for displaying information about the physiological condition such medical condition, trait, or wellness condition (hereinafter referred to as the “Fifth Module” or the “Informational Module”). The Informational Module may include a title 605 identifying the physiological condition. In the continuing example of Bloom Syndrome, the exemplary medical condition, the title Informational Module may be titled “About Bloom Syndrome” (605a) to indicate to the user that the Informational Module provides information regarding the medical condition displayed in the Title Module. The title 605 is particularly useful to identify the physiological condition for which information is being presented for cases in which the Title Module identifies several physiological conditions. For example, title 605b indicates that the this particular Informational Module relates to Widow's Peak, one of the traits identified in the exemplary Title Module provided in FIG. 2b. The Informational Module may also include heading subtext 610 identifying alternative names associated with the medical condition of interest, if any (e.g., “Also called: Bloom's Syndrome”). Alternatively, as shown in FIG. 6b, the heading subtext 610 may provide information about the physiological condition identified in title 605.

Below the title and heading, the Informational Module may organize the physiological condition information into several sections to facilitate user comprehension; the user is signaled in to the categories of information by familiar graphical icons (elements 620, 630 and 640). Dividers (reference numeral 650) also may be used to distinguish between the different categories of information. Thus, as shown in FIG. 6a, the information displayed below icons 620a, 630a, and 640a, respectively, concern (i) ethnicities most affected by the medical condition (text element 621) (ii) how symptoms associated with the medical condition develop and are treated (text element 631), and (iii) typical signs and symptoms of the medical condition (text element 641). Optionally, graphical elements may be incorporated into the text elements 621, 631, and/or 641 to illustrate the principles presented and facilitate user comprehension. The information may be categorized into further subsections (e.g., “When symptoms develop” and “How it's treated”) and displayed using short sentences and/or bullet lists to facilitate user comprehension. The information displayed below icons 620, 630 and 640 may also include hyperlinks 655 to further, detailed information for user consideration.

FIG. 6b is a block diagram exemplifying an alternate format of the Informational Module that may be useful for presenting information about any physiological condition but is styled with reference to a trait for purposes of illustration. Below the title 605b and the optional subtext 610b is a series of series of columns, each providing information on a single topic relevant to the physiological condition referenced in the module title 605b and the Title Module. Each column optionally has a title and/or a graphical element (e.g., 620b, 630b, and 640b) indicating the subject matter of the column. The information presented in each column is preferably a combination of short sentences and/or bullet lists and/or graphical elements to facilitate user comprehension (e.g., 621b, 631b, and 641b). The information presented in the Informational Module need not be limited to medical information relating to disease causes, development, and progression. For traits and wellness conditions, suitable topics include, but are not limited to, the history of the development or discovery of the trait or wellness condition, and the biological/biochemical and/or genetic underpinnings of the phenotype or expression of the trait or wellness condition.

Sixth Module—Recommendation Module

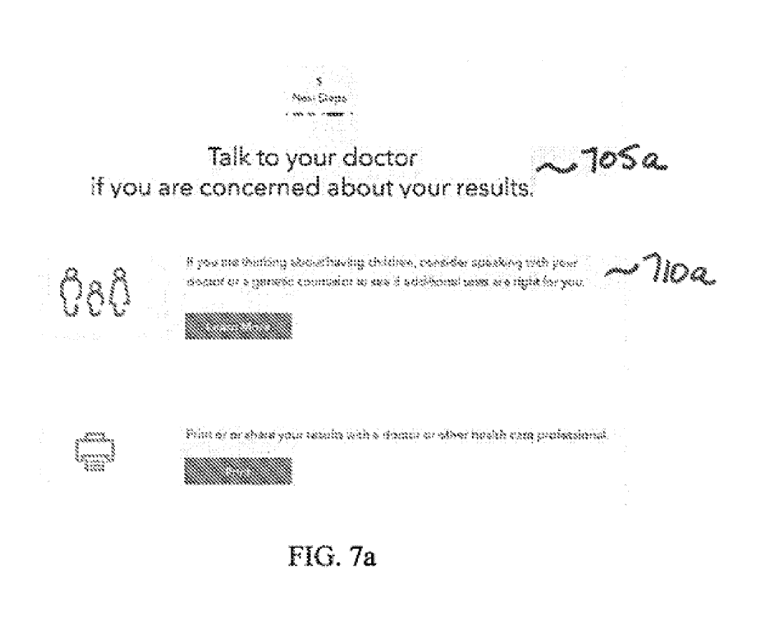

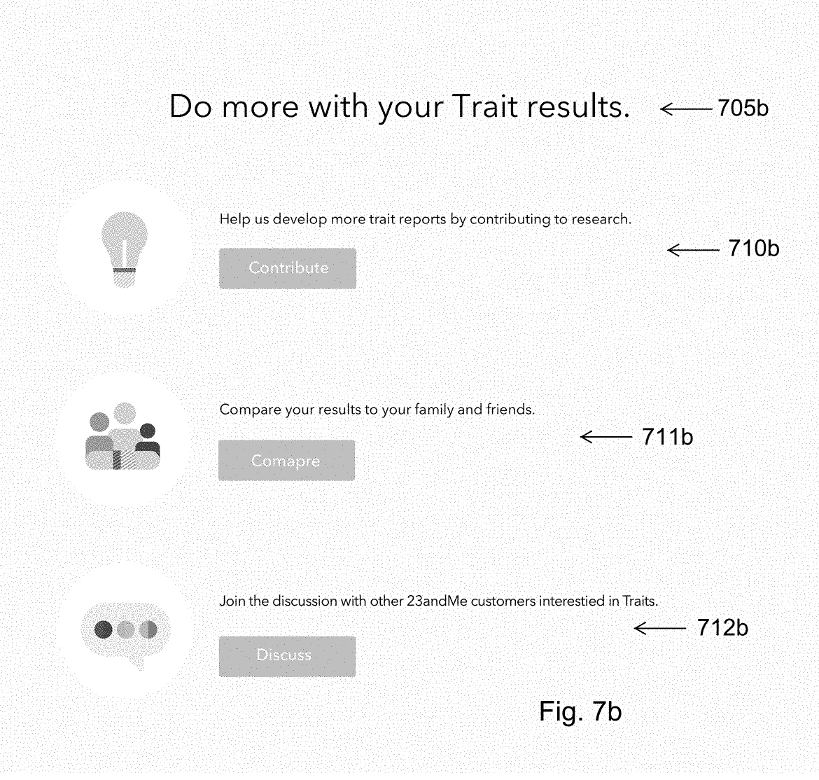

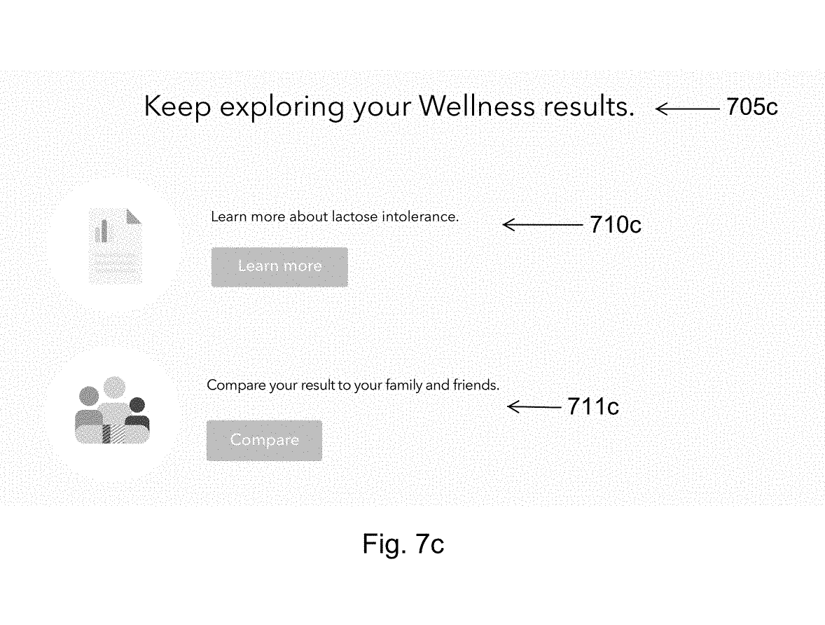

FIG. 7 provides block diagrams illustrating an exemplary Recommendation Module which may be presented as module 165 for recommendation information for user action (hereinafter referred to as the “Sixth Module” or the “Recommendation Module”). In one embodiment, the Recommendation Module has a call to action 705 displayed prominently (e.g., larger font size, different font, and/or different color relative to other module elements) and is located at or near the top of the module. For example, particularly in the case of medical conditions, the call to action 705a may be an instruction to consult a physician. Alternatively, the call to action may indicate that no further action is needed or desired. In the case of traits or non-medical conditions, the call to action 705b may be for the user to input addition demographic, physical, and/or physiological information which, optionally, may be stored in the results database. In other cases, the call to action 705c may be to review other reports and/or user information contained within the results database.

Following the call to action 705, the module provides additional information, hyperlinks, or user-defined actions consistent with the call to action. In the case of medical conditions, for example, the Recommendation Module may provide summary or status information 710 in the form of text, graphics, or both. Element 710a, for example, indicates that “Jamie” should consult a physician if she is considering having children. There is no limit on the number or types of user-defined actions or prompts provided in the Recommendation Module. And, the user-defined actions need not directly impact the user's health. Elements 710b, 711b, and 712b, for example, provide the user with an opportunity to input additional personal information, compare their results to other related and unrelated individuals (also see 711c), and contribute to a relevant discussion forum, respectively. The user-defined action may include a hyperlink 710c to a separate module or web page that provides additional information about the physiological condition.

Seventh Module—Combined User Information/Interpretation Module

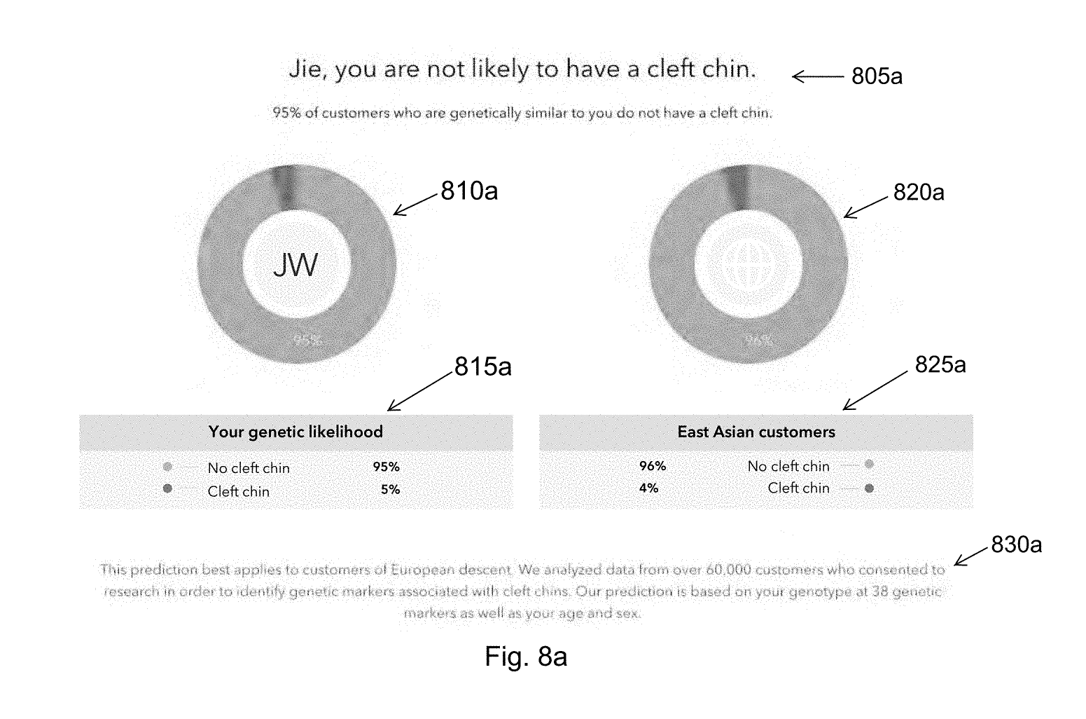

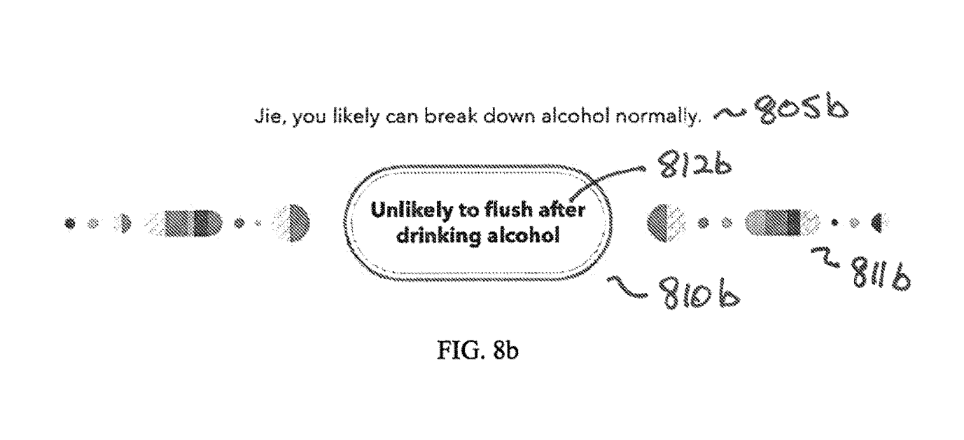

FIG. 8 is a block diagram of an exemplary combined user information/interpretation module (hereinafter referred to as the “Seventh Module” or “Combined User Information/Interpretation Module”). The Seventh Module contains all of the features and information types of the User Information Module and the Interpretation Module. Typically, a web page template contains either the Seventh Module or the User Information and Interpretation Modules. The Seventh Module is particularly useful for presenting, in a highly comprehensible manner, genetic information and interpretations relating to polygenic traits, and particularly those traits having a genetic contribution from at least two, three, four, five, ten, twenty, or more distinct genes and/or wherein the presentation of results from individual genes is not necessary or is confusing to the user, and is better presented in summary fashion. The Seventh Module is particularly useful for presenting genetic information and interpretations related to traits and wellness conditions.

The Seventh Module may, but does not necessarily include a navigational element that either draws attention to the user's genetic information (e.g., by causing the web page to center on those elements) or causes the web page to scroll or jump to other modules of the web page associated with the respective navigational elements. The Seventh Module optionally contains a section title (not shown). The Seventh Module provides an interpretation of the user's genetic information may be displayed as graphical element, a textual element, and/or as a single element that is a combination of graphical and textual elements. For example, FIGS. 8a and 8b provides a text statement 805 of the interpretation of the user's genetic information. Preferably, text statement 805 is in the form of a short declarative statement or bullet point. Optionally, the Seventh Module provides a graphical representation of the user's genetic information. The graphical representation may be co-extensive with the text statement 805 or provide additional information or specificity. Graphical representation 810a provides a visual indication of the likelihood that the user has the physiological condition (cleft chin) of interest. Optionally, a textual and/or tabular representation 815a is also provided. Optionally, the Seventh Module provides population information 820a and 820b, derived from a relevant population of individuals, for the physiological condition of interest and is presented in the same format as the user's genetic information. Optionally, the module provides additional limitations and qualifications 830a on the testing or comparative methodology and/or the reference population identified in 820a and 825a.

An alternative embodiment for the presentation of the user's genetic information is shown in FIG. 8b. Element 810b is a combined graphical and textual representation of the interpretation of the user's genetic information. The graphical portion of the 811b element 810b may be informative or merely used to draw the user's attention to the textual portion 812b. The textual portion 812b contains a short declarative statement or bullet point providing a functional outcome or other information related to the interpretation provided in 805b.

Although the foregoing examples related to physiological conditions of the user, the interpretation and other information presented in the Seventh Module may instead relate to the probability that an offspring will have the physiological condition of interest based on an analysis of the user's genetic information. Such an interpretation may be modified by information about the actual status of the user's physiological condition of interest.

Although the Seventh Module is exemplified herein in terms of specific elements, the Seventh Module may contain any individual elements described for the User Information Module and/or the Interpretation Module. In one embodiment, the web page contains the Seventh Module and lacks the User Information Module and Interpretation Module. In another embodiment, the web page contains the User Information Module and Interpretation Module, and lacks the Seventh Module. The Seventh Module, when present, may be displayed adjacent to and/or below the Title Module. Preferably, the Seventh Module is positioned below and adjacent to the Title Module.

Eighth Module—Inheritance Module

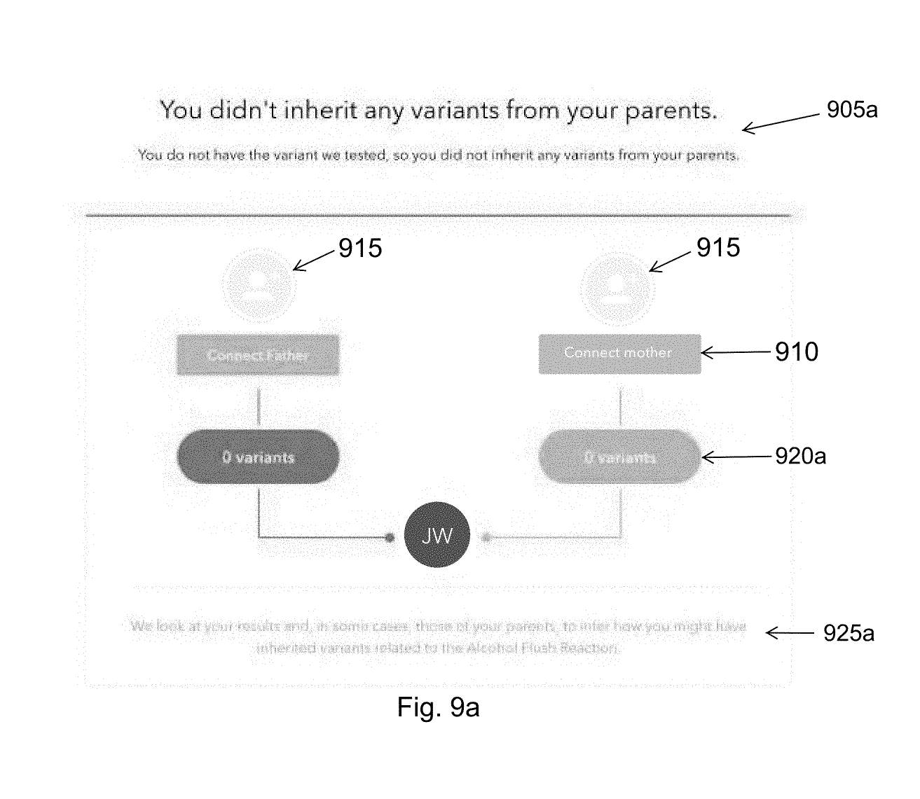

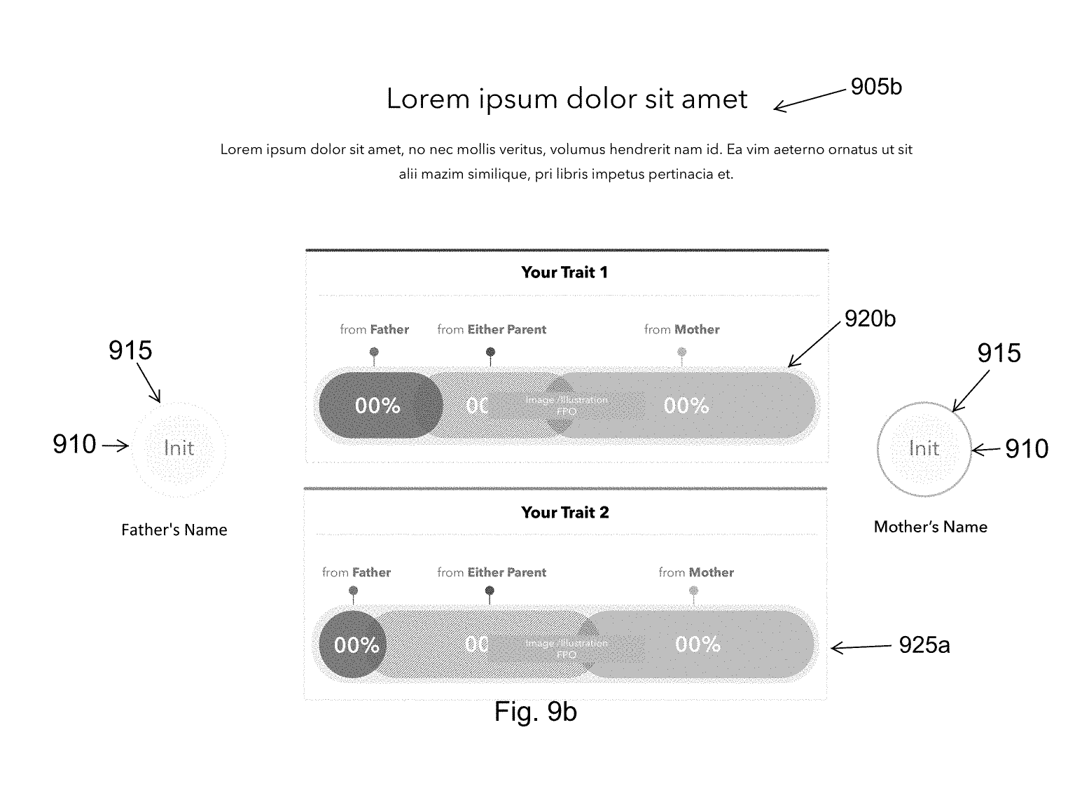

FIG. 9 illustrates block diagrams of an exemplary Inheritance Module (hereinafter referred to as the “Eighth Module” or “Inheritance Module”) and displays user information relative to that of other individuals of interest include genetically-related family members and non-family members (e.g., spouses). The Inheritance Module contains a text element 905 stating the relationship and/or inheritance of the physiological condition from one or more genetically-related family members (e.g., parents). The Inheritance Module optionally contains one or more a user interfaces 910 to link the user's genetic information with the genetic information of one or more other users that is contained in the results database. In one embodiment, the user interfaces 910 are disabled when one, two, three, four, or more genetically-related family members (e.g., parents and grandparents) are linked. Optionally, the Inheritance Module provides a picture, photograph, or other unique icon 915 identifying each linked individual. Preferably, the genetic information of the other user remains hidden from the user and only summary or interpretative information is presented. Other users may include genetically-related family members such as parents, grandparents, great grandparents, siblings, aunts, uncles, cousins, children, grandchildren, and the like, and non-genetically related individuals such as spouses. Alternatively, the linkage of the user's genetic information with that of other users is provided separately and contained within the results database before the web page display is generated. In such an embodiment, the user interface is not present or hidden.

Below the title and heading 905, the Eighth Module may provide information that indicates the likelihood of and/or relative genetic contribution that any other individual may have made (in the case of the individual/user) or has the potential to make (in the case of the predictive genetic contribution to a child) based on the combination of the user's genetic information and that of the other user(s). As illustrated in FIG. 9, the inheritance information may be presented as a graphical element 920b, 921b, a textual element, and/or as a single element 920a that is a combination of graphical and textual elements to indicate the relative contribution or probability of contribution of genetic information to the physiological condition of interest. Optionally, the Eighth Module may provide additional predictive or probabilistic information 925 based on scientific or empirical data obtained from a relevant population but without reference to the genetic information of the linked individuals.

The Inheritance Module, if present, is optionally positioned below the First, Second, Fourth, and/or Seventh Modules. The Inheritance Module may be positioned above or below the Third and/or Ninth Modules.

Ninth Module—Non-Genetic Information Module

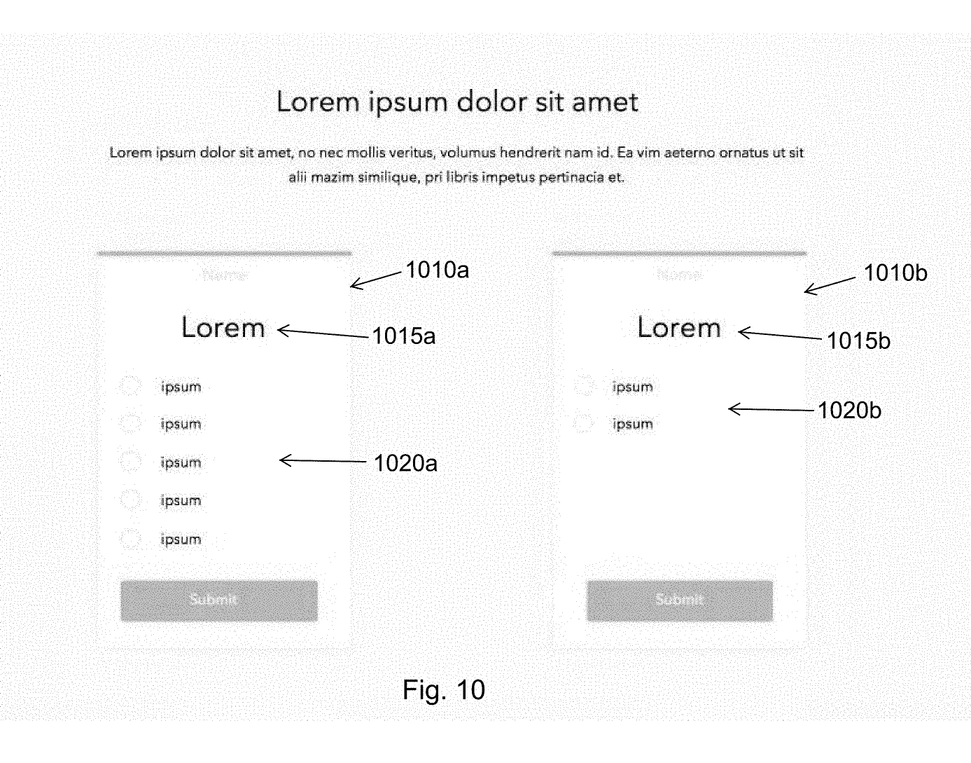

FIG. 10 is a block diagram of an exemplary non-genetic information module (hereinafter referred to as the “Ninth Module” or the “Non-genetic Information Module”). This module provides a user interface for entering information and a mechanism for transferring that information to the results database to be stored in association with the user's genetic information. The interface may allow for the input of any type of information and in any form, including textual. In one embodiment, the module provides a series of questions or statements to solicit information and presents the user with a pre-determined menu of responses (e.g., radio buttons, check boxes, etc.). Any type of information may be solicited including demographic information (e.g., age, gender, ethnicity, etc.), lifestyle information (e.g., practices related to diet, exercise, nicotine use, etc.), trait information (e.g., hair color, eye color, skin tone, etc.), and wellness information (e.g., blood pressure, cholesterol level, etc.). The non-genetic information entered by the user may be used to further interpret, analyze, or make recommendations based on the user's genetic information. Alternatively, the non-genetic information may be used to in the calculation of relevant population information presented in other modules. FIG. 10 illustrates a non-genetic module soliciting two pieces of information. Each question is physically segregated in a question box 1010 which contains the question text 1015 and a response input 1020. However, any number of questions or pieces of information may be solicited (e.g., one, two, three, four, five, ten, twenty, or more).

The Non-genetic Information Module may be positioned anywhere within the template. In some embodiments, the Non-genetic Information Module is positioned below the First, Second, Fourth, Fifth, and Eighth Modules, if present. Optionally, the Non-genetic Information Module is the last module displayed on the web page.

Web Page Construction From Template

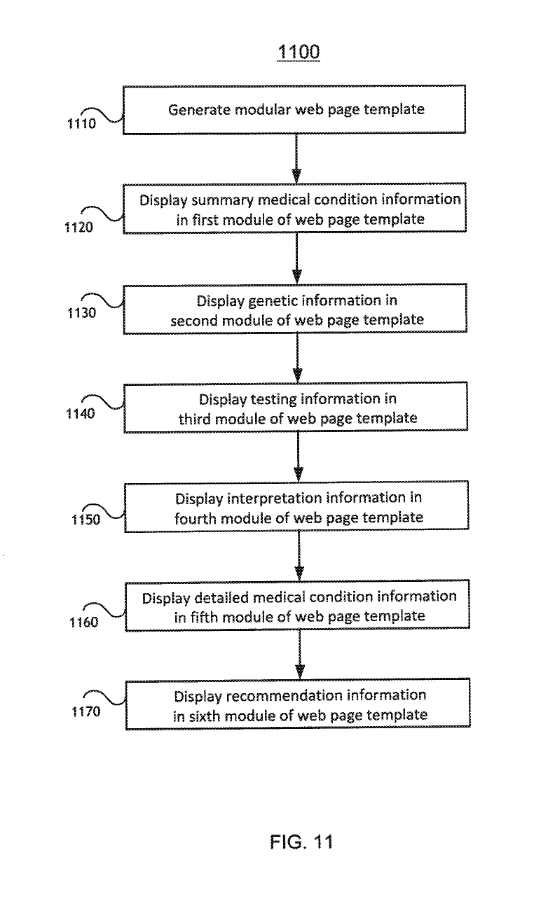

FIG. 11 is a flowchart illustrating an exemplary method 800 for constructing a modular web page. At step 1110, method 1100 may generate an electronic template for a web page using a processor of a computing platform. The electronic template is exemplified to include modules 140, 145, 150, 155, 160 and 165 described in connection with FIGS. 2-7, however, it may be modified to include any of modules described herein. At step 1120, method 1100 may display medical condition information in the First Module, including, for example, the medical condition name, medical condition description, and condition-associated genes. Method 1100 may access medical database 170 to obtain the medical condition name, medical condition description, and condition-associated genes. At step 1130, method 1100 may display genetic information in the Second Module, including, for example, genetic information for one or more of the condition-associated genes obtained at step 1120. Method 1100 may access genetic information database 175 to obtain the genetic information. At step 1140, method 1100 may display testing information in the Third Module, including, for example, intended use information about the intended use of a test used to determine the genetic information obtained at step 1130. Method 1100 may access testing information database 180 to obtain the intended use information.

Method 1100 at step 1150 may display interpretation information in the Fourth Module obtained by accessing medical database 170. At step 1160, method 1100 may display medical condition information in the Fifth Module obtained by accessing medical database 170. The medical condition information may include additional detail (for example, typical signs and symptoms, how the condition develops and is treated, and the ethnicities most affected) relative to the information displayed in the First Module at step 1120. At step 1170, method 1100 may display recommendation information in the Sixth Module obtained by accessing medical database 170. The recommendation information may be based on information personal to the user, such as the user's determined carrier status. Method 1100 may display information at steps 1120 through 1170 in varying configurations, consistent with the disclosed embodiments and the description of modules 140, 145, 150, 155, 160 and 165 described in connection with FIGS. 2-7, above.

Scientific Detail Module

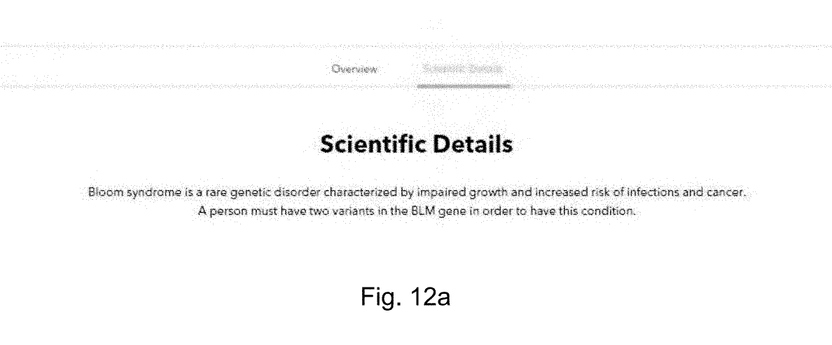

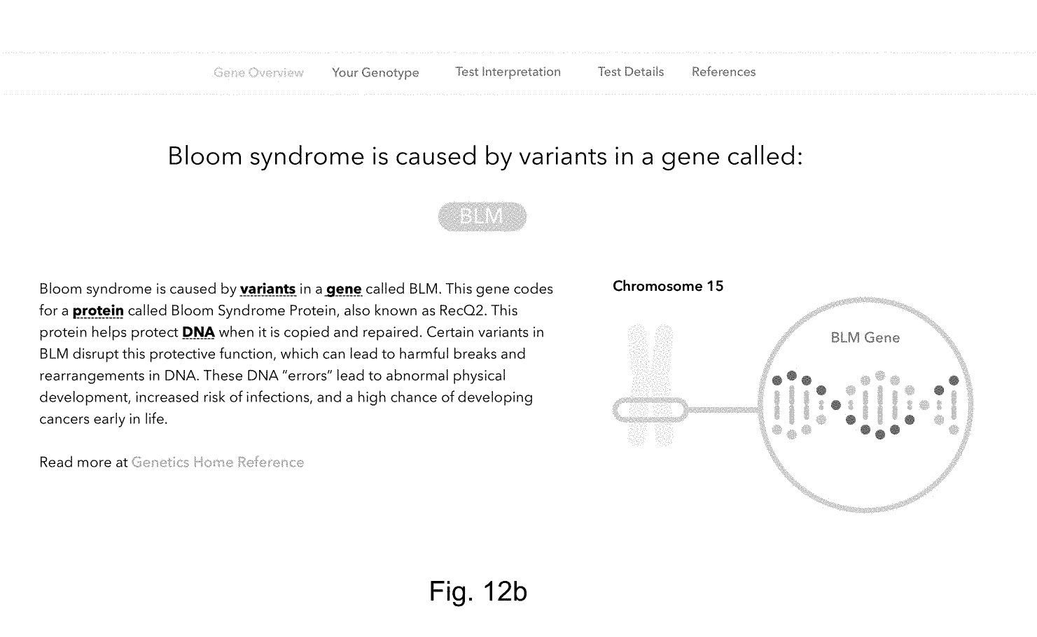

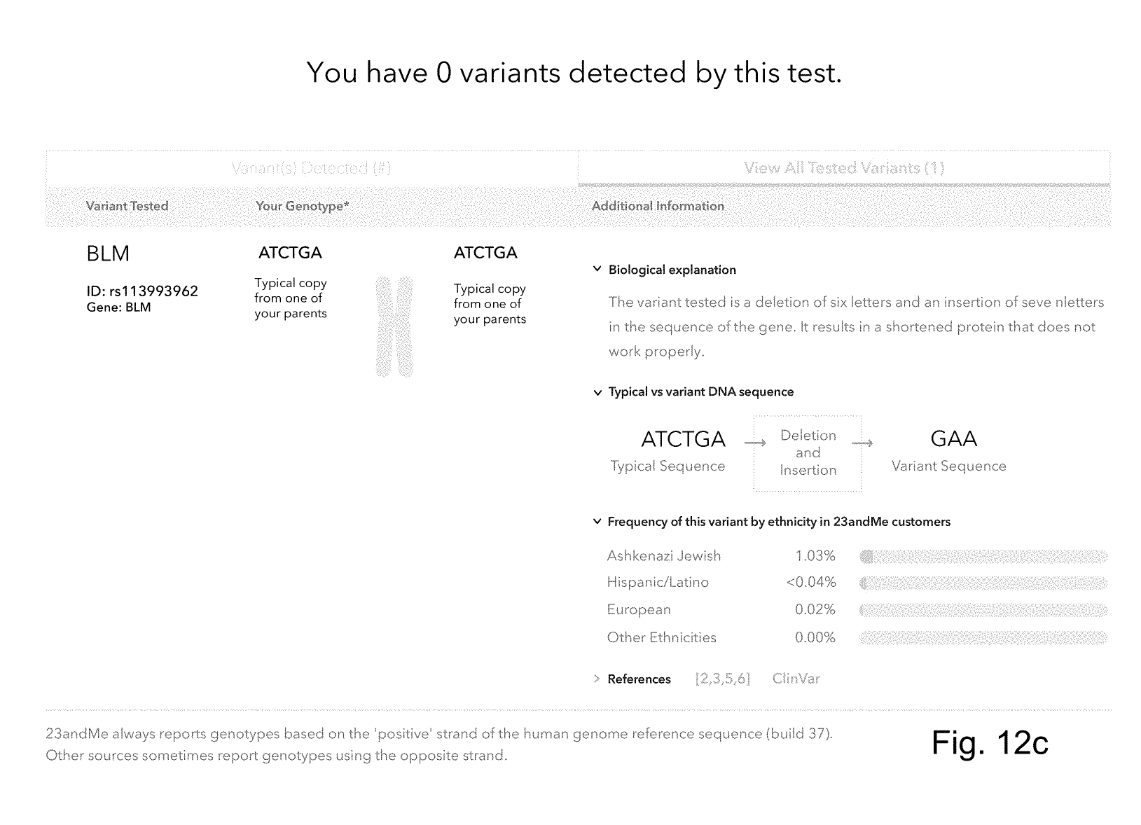

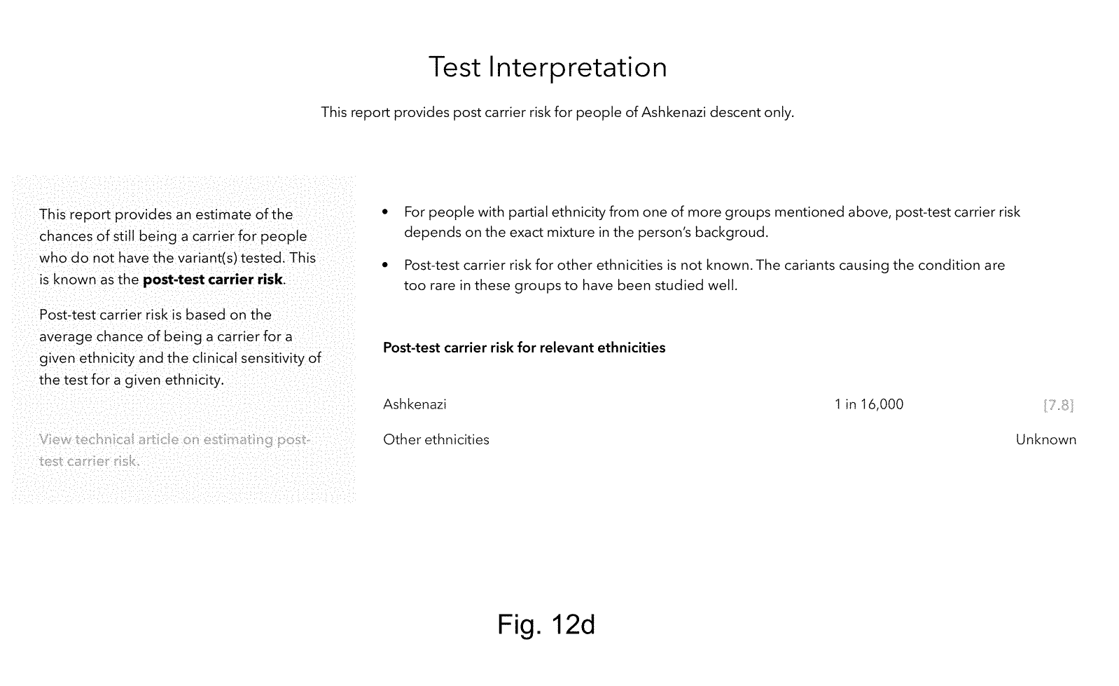

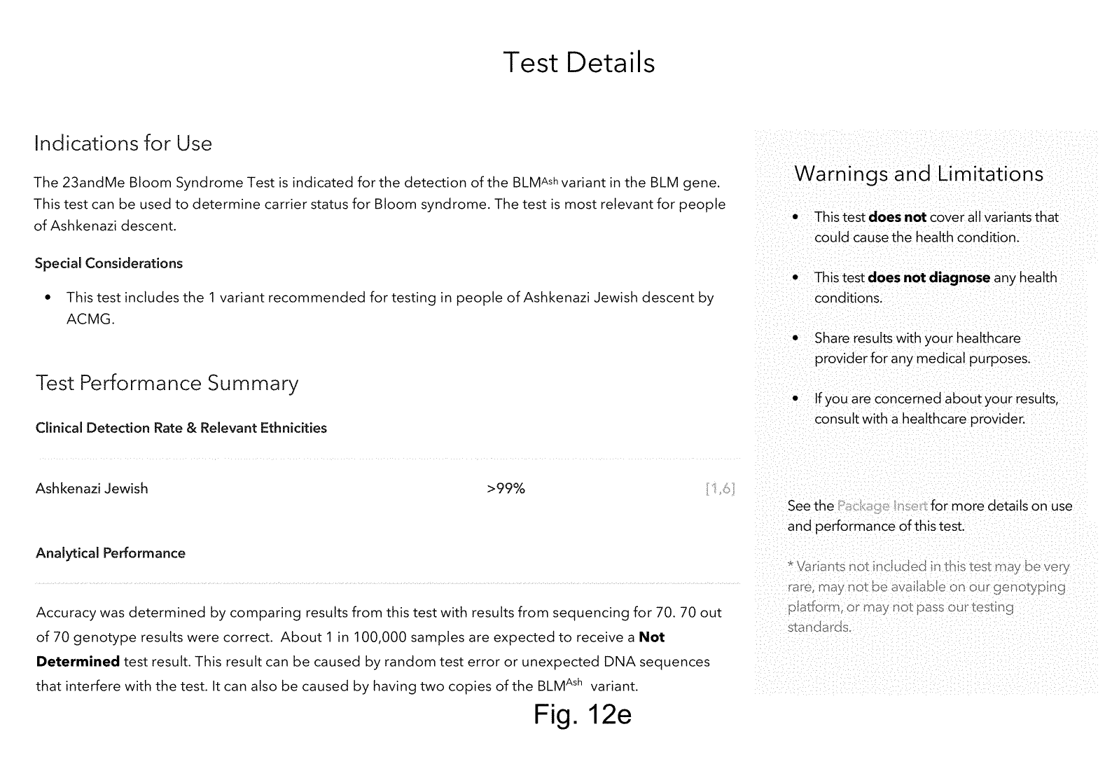

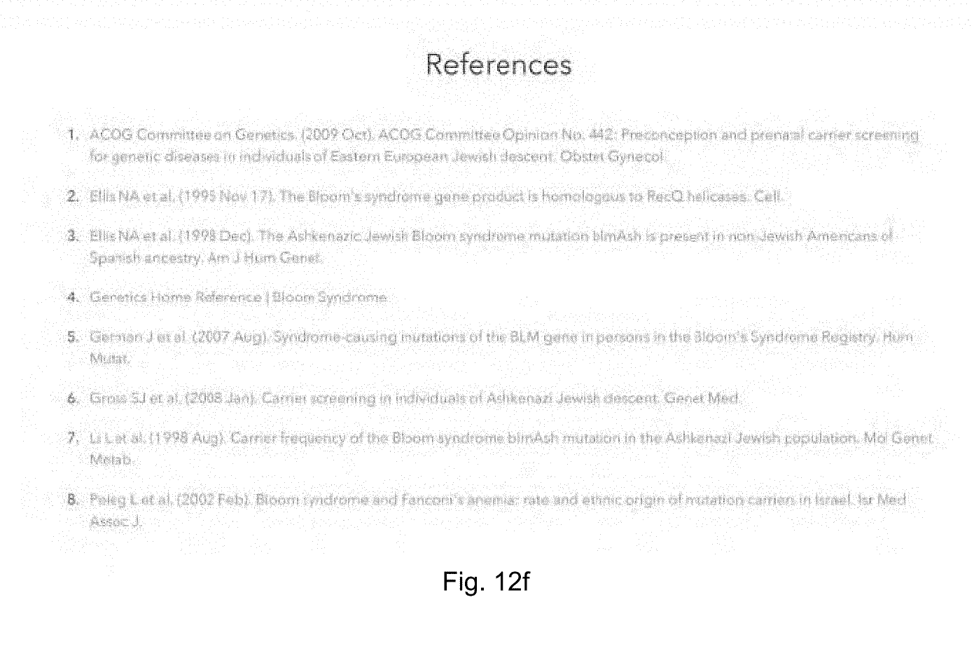

In addition to the information displayed in the First through Ninth Modules as described above, the user may be provided with electronic access (for example, through hyperlinks and clickable buttons) to further resources and information, for example, through scientific detail module 190. Scientific detail module 190 may be a second web page. Examples of further resources and information provided in scientific detail module 190 are illustrated in FIGS. 12a-12f As shown in these figures, the scientific detail module 190 may include sections that provide the user with information beyond what is displayed on the first web page using web page template 100. Each of these sections may include hyperlinks to more detailed scientific and technical information, should the user desire access to such information.

As shown in FIG. 12a, scientific detail module 190 may include a navigational element (“Scientific Details”) and a vertical navigational bar (not pictured). The navigational element may appear in a font (e.g., blue, bolded font) that distinguishes the navigational element text from the other displayed text describing Bloom syndrome. A user clicking on the navigational element may cause the web page to center on the text describing Bloom syndrome.

As shown in FIG. 12b, scientific detail module 190 may also include additional navigational elements: “Gene Overview” (associated with the section illustrated in FIG. 12b), “Your Genotype” (FIG. 12c), “Test Interpretation” (FIG. 12d), “Test Details” (FIG. 12e), and “References” (FIG. 12f). Clicking on one of these navigational elements may cause scientific detail module 190 to scroll or jump to the section associated with that navigational element.

The section illustrated in FIG. 12b may describe the structure and function of the gene of interest (e.g., BLM) and explain how variants of that gene can cause certain medical conditions (e.g., Bloom Syndrome). Next, the section illustrated in FIG. 12c may describe detailed personal and genetic information of the user, along with explanatory text directed to the underlying biology, typical vs. variant DNA sequences, and statistical frequency information of the variant (e.g., based on ethnicity). Optionally, the user may access the explanatory text by clicking on the bullet points, which causes the section to expand and the explanatory text to be displayed. Structuring the section in this manner reduces clutter and may increase user comprehension and the overall user experience.

The section illustrated in FIG. 12d may provide further information on the estimated chance of being a carrier for an individual who does not have the tested variant(s) (referred to as “post-test carrier risk”). The further information may include statistical data based on ethnicity (e.g., the average chance that an individual of a given ethnicity is a carrier). Additionally, the section illustrated in FIG. 12e may describe detailed information on the test that was used to analyze the user's DNA. Information in this section includes a description of how the test was implemented, the relevance and limitations of the test, and overall test performance (e.g., how accurate the test is). The section illustrated in FIG. 12f may provide a listing of technical sources, such as journal articles and scientific websites, which the user may access for additional information.

Education Module

To better comprehend the information displayed in First through Ninth Modules as described above, the user may be provided access to an electronic educational module 185. Educational module 185 may be a third web page and may be presented either before, during (e.g., in a split-screen mode in which the user can independently access and scroll through either the web page template or the education module), or after displaying the other modules; although an earlier presentation of the education module 185 is preferred. The education module 185 may be presented as part of the same web page as the First through Ninth Modules, or it may presented as a separate web page. An exemplary educational module 185 is illustrated in FIGS. 13a-f. As shown in these figures, educational module provides the user with background information—such as a carrier status tutorial—that will help the user understand their personal genetic and medical condition information provided in foregoing modules.

As shown in FIG. 13a, for example, educational module 185 informs the user of the purpose of the information displayed in the report page template. For example, the education module may contain information about the medical condition, testing methodology, and/or interpretation of various testing results. As exemplified in FIG. 13a, the carrier status report (“Our Carrier Status reports tell you about gene variants that may not affect your health, but could affect the health of your family. The following concepts may help you understand your reports.”). Thus, the user is likely to understand the significance of completing the tutorial provided in educational module 185.

In the examples provided in FIGS. 13b and 13c, educational module 185 provides the user with the definition of a carrier (“a person who has one gene variant for a recessive health condition”) and gene variant (“a change from the normal DNA sequence of the gene”) and an explanation of how the parents' carrier status may impact their children (“Carriers do not have the genetic condition. But, they can pass a gene variant down to their children. If both parents are carriers, their child may inherit two variants and have the condition.”). The definitions and explanations in these figures are associated with graphical text elements (e.g., the genes depicted and labeled in the center of FIG. 13b, and the parent-child tree diagram illustrated in FIG. 13c) using concepts similar to those discussed above in connection with the First through Ninth Modules, in order to facilitate user comprehension of this background material. Thus, carefully reviewing the information displayed in FIGS. 13b and 13c will better prepare the user to understand his or her personal genetic and medical information.

Continuing to FIG. 13d, educational module 185 provides the user with examples of the results that the user can expect to receive in connection with reviewing the First through Ninth Modules. The user is provided with a brief description of each result type (“Likely not a carrier,” “Carrier,” “Not determined”). As shown in FIG. 13e, the user is informed that ethnicity may play a role in determining the user's carrier status (“Your ethnicity matters because genetic conditions affect certain ethnicities more than others. If a genetic condition has been studied in your ethnicity, our reports can provide more detailed information for you.”). Thus, the user is likely to understand that a connection exists between his or her ethnicity and whether or not the user is a carrier (with the different carrier status categories described in FIG. 13d). Finally, FIG. 13f explains the significance of the carrier status determination (“Knowing your carrier status is important when starting a family. Our reports can help you understand your chances of carrying a variant that could be passed down to your children.”) and the limitations of that determination (“Our tests do not diagnose any medical conditions.”). After completing the tutorial provided by educational module 185, the user is in a better position to understand the information displayed in the First through Ninth Modules, as well as the significance and limitations of their personal genetic and medical condition information.

Comprehension Testing

As indicated throughout this disclosure, one goal of the disclosed embodiments is to facilitate and increase user comprehension of personal genetic and medical condition information. Specifically, it is important that users who receive a test report related to their personal genetic and medical condition information understand several key concepts, including purpose of the test, limitations of the test, meaning of the reported results, and appropriate follow-up actions. The various modules of the disclosed embodiments described above are the result of substantial research, testing, and refinement to increase user comprehension.

For example, different configurations of the disclosed embodiments were tested using a moderated user comprehension study. The study measured user comprehension of the information provided in a sample test report by asking respondents to answer a series of questions based on different scenarios: “Carrier” (the sample test report indicated that the tested individual was a carrier of the tested BLM gene variant), “Absent—Match” (the tested individual was not a carrier but the individual's ethnicity was full Jewish), “Absent—Partial” (the tested individual was not a carrier but the individual's ethnicity was partial Jewish), “Absent—No Match” (the tested individual was not a carrier and the individual's ethnicity was non-Jewish), and “No Call” (the tested individual's carrier status could not be determined). The number of respondents that answered each question correctly for each scenario (expressed as a percentage) are provided in Tables 1, 2, and 3, below. For example, for the sample test report associated with Table 1 in which the tested individual was identified as a “Carrier,” 66% of respondents correctly answered question no. 1.

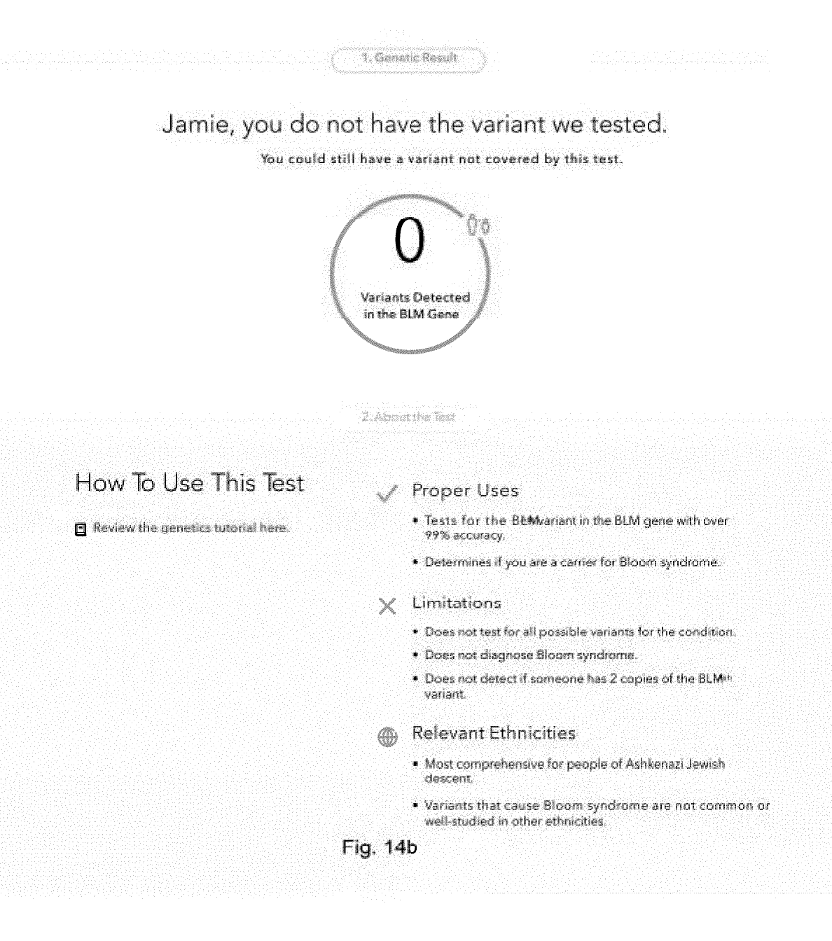

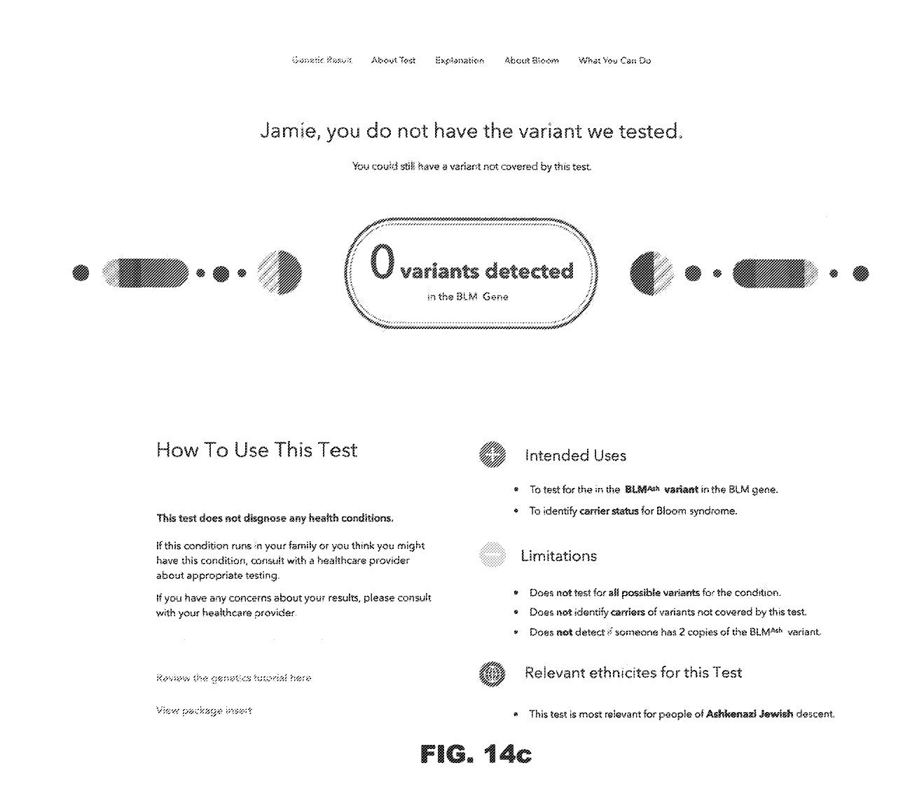

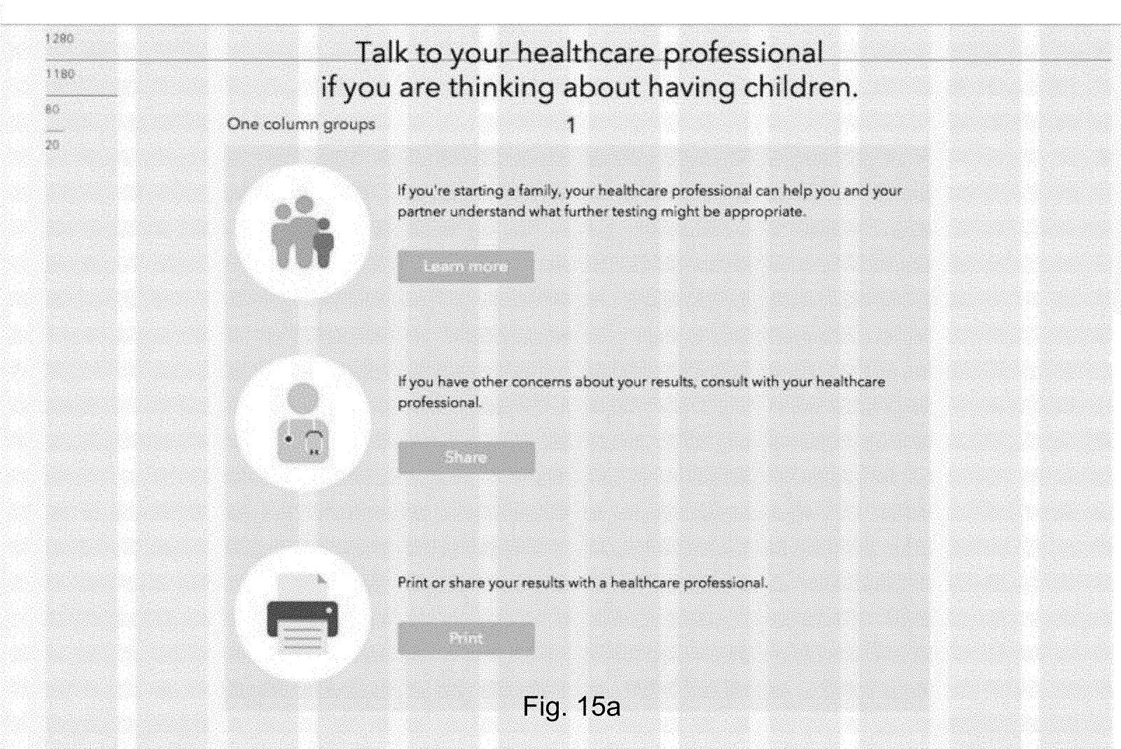

The modules depicted in FIG. 14a correspond to the “Absent—Match” column of Table 1 (that is, the sample test report indicated that the tested individual was not a carrier and was full Jewish).

The modules depicted in FIG. 14b correspond to the “Absent—Match” column of Table 2, below:

A comparison of Tables 1 and 2 reveals that, except for question no. 5, an equal or larger percentage of respondents who were shown a sample test report illustrated by the modules of FIG. 14b answered the questions correctly, relative to their counterparts who were shown a sample test report illustrated by the modules of FIG. 14a. Compared to FIG. 14a, the modules depicted in FIG. 14b have several advantages resulting in higher user comprehension:
Larger amounts of white space, making the modules easier to process visually;
Smaller amounts of text, with increased spacing between text elements;
Greater emphasis on key text elements (such as headings and subheadings) by using larger font sizes and associating those elements with larger graphical elements (such as icons); and
Additional structure, such as labels (e.g., “1. Genetic Result”) and bullet point lists, to better organize and present the information.

The modules depicted in FIG. 14c correspond to the “Absent—Match” column of Table 3, below:

Similarly, a comparison of Tables 2 and 3 reveals that, except for question no. 2, a larger percentage of respondents who were shown a sample test report illustrated by the modules of FIG. 14c answered the questions correctly, relative to their counterparts who were shown a sample test report illustrated by the modules of FIG. 14b. Compared to FIG. 11b, the modules depicted in FIG. 14c have certain advantages resulting in higher user comprehension:
Greater use of contrasting visuals that are more effective in capturing the user's attention and directing the user to key text elements (e.g., “0 variants detected”);
A balanced presentation of text elements. For example, comparable amounts of text are present on both sides of the page; and
Greater use of contrasting font sizes and bolding for text elements, to more effectively highlight the key takeaways for the user.

As can be seen from the progression from FIGS. 14a through 14c, distilling the information within the modules to the core comprehension concepts improves user comprehension. Among other reasons, this improvement in comprehension is driven by the increasing use of white space to separate information into more manageable (e.g., “bite-size”) content elements, and the clear delineations between various modules, which enable each module to provide stand-alone content.

Web page template 100 may be characterized as having certain amounts of “positive space” and “negative space” (also referred to as “white space”) which may be measured either globally (on the template as a whole) or within any individual module. Positive space may be understood as referring to the amount of space on a web page that is occupied by text elements and graphical elements. Conversely, negative space may be understood as referring to the amount of unoccupied space on a web page. The relative amount of negative space on a web page may be determined by the equation 1—{positive space/total space}, where each of positive space and negative space is expressed as a relative proportion of the total area being measured. Positive and negative space is measured based on the size of the various informational blocks (e.g., text and graphical elements). For example, a paragraph of text that occupies 50% of the page would be considered to be entirely positive space even though there are a significant number of negative (e.g., white) pixels within the text. It may be convenient to apply weighting factors to informational elements of different types. For example, graphical elements tend to incorporate more negative space within the element itself and also tend to convey less information relative to a textual informational element. However, it was found that user comprehension of the information presented in graphical form was understood and retained (i.e., comprehended) better than the same information presented in a textual element. A reduced weighting may be applied to graphical elements in the calculation of positive space.

It was determined that user comprehension of genetic, diagnostic, and medical information, of the type presented herein, was increased with increasing amounts of negative space and/or use of graphical elements in conjunction with text elements. For example, it was found that user comprehension was increased when textual elements were simplified and deemphasized in favor of more prominent graphical elements paired or linked with the text elements. This indicates that users typically have better comprehension of information appearing in text elements that is reinforced through use of graphical elements. Thus, the positive space calculation may be used as an index of an expected user comprehension, wherein lower amounts of positive space are associated with increases in user comprehension. Accordingly, the calculation may be adjusted using weighting factors in which graphical elements are accorded a lower weight than textual elements. The weighting factor may relate to, or otherwise indicate the amount of negative space within the graphical element itself, or the weighting factor may be fixed. These principles are illustrated by the following examples.

### Example 1

The web page comprises two textual elements, each occupying 50% of the web page. Both the weighted and unweighted calculations indicate a positive space approaching 100% which correctly implies reduced user comprehension relative to layouts incorporating graphical elements in conjunction with text elements.

### Example 2

The web page comprises two graphical elements, each occupying 50% of the web page and each disclosing that the user has a single mutation in each of two genes (e.g., similar to element 320). The unweighted calculation indicates a positive space approaching 100%. However, user comprehension is high given the simple and graphical nature of the presentation. According the graphical elements a lower weight would reduce the calculated amount of positive space and more closely correlate with the expected user comprehension. In practice, many graphical elements will contain some textual information (e.g., element 320) and it is expected that user comprehension of graphical elements comprising large amounts of text will be reduced compared to graphical elements containing little or no text. Accordingly, it is preferred that the weighting factor account for the amount of positive and negative space within the graphical element itself.

Consistent with these examples, it is preferred that text elements displayed on web page template 100 (and/or in a module appearing on web page template 100) account for less than 50% of the positive space. In other words, it is preferred that white space and graphical elements account for more than 50% of the space on web page template 100 (and/or in a module appearing on web page template 100).

Grid-Style Layout of Web Page and/or Modules

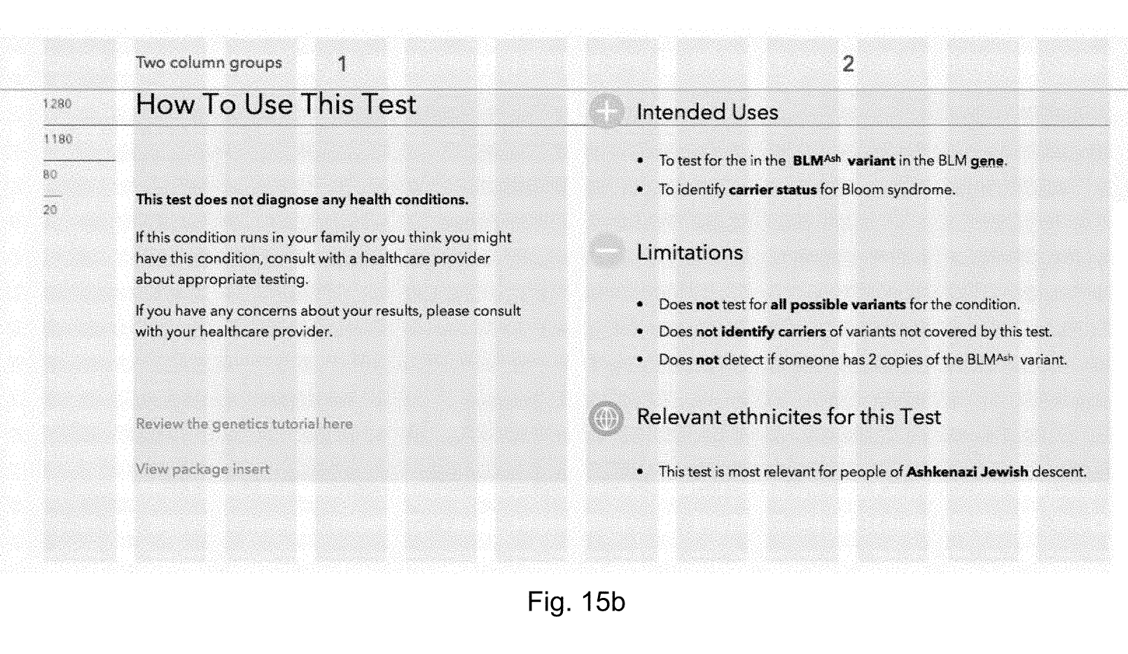

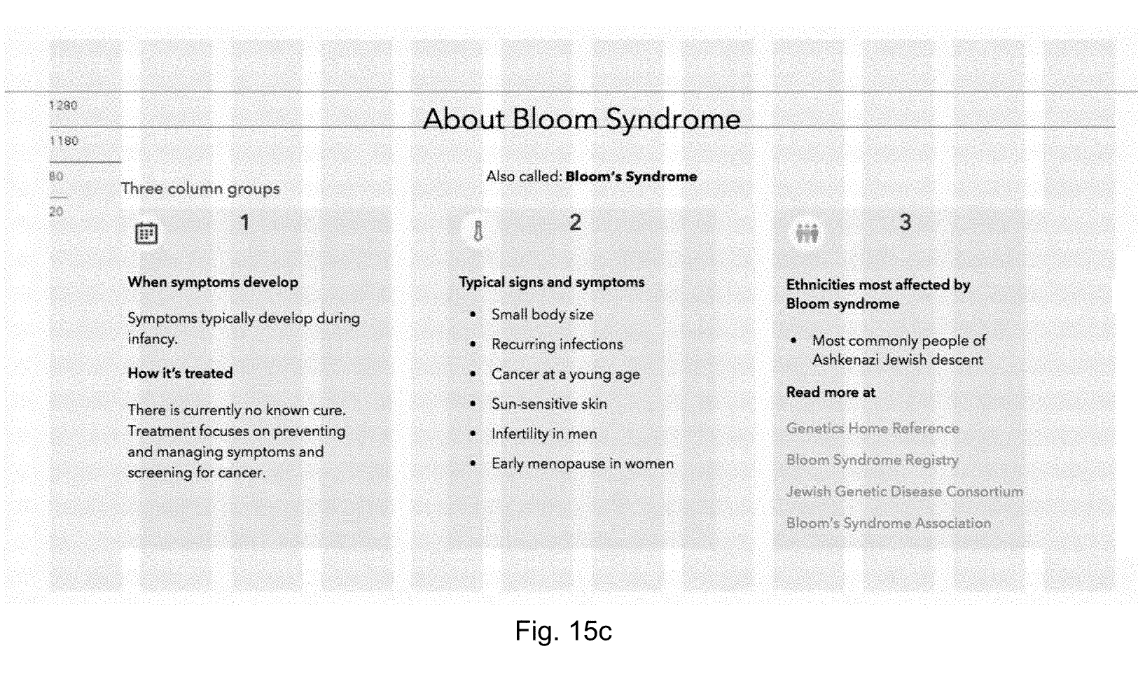

In some embodiments, a grid system is used to further increase user comprehension levels. As illustrated in FIG. 15a, for example, web page template 100 may be partitioned into a 20 pixel (abbreviated as “px”) baseline grid made up of squares with 20 px sides. Different configurations of the baseline grid are possible; the disclosed embodiments are not limited to a 20 px grid. The grid may be further organized into a series of columns, for example, 12 columns. Each column may optionally be separated from adjacent columns by a buffer of predetermined width (for example, 20 px). This framework may be projected against a structural “canvas” with a width of 1280 px and a content canvas with a width of 1180 px. The result is a buffer or frame of padding that surrounds the content canvas, therefore providing a visual offset that helps focus the user's attention to the regions on the web page where content is displayed. The disclosed embodiments are not limited to any particular values for the width of the structural canvas and content canvas.

In some embodiments, the modules displayed on web page template 100 may be divided into 12 columns. Each of the 12 columns may then be further grouped into groups of 1, 2 or 3 columns. For example, the 12 columns depicted in FIG. 15b are divided into two column groups corresponding to the content appearing, respectively, on the left side of the web page (“How To Use This Test”) and the right side of the web page (“Intended Uses,” “Limitations,” and “Relevant Ethnicities for this Test.” Similarly, in the example provided in FIG. 15c, the 12 columns are divided into three column groups corresponding to the content appearing, respectively, on the left side of the web page (“When symptoms develop” and “How it's treated”), the center portion of the web page (“Typical signs and symptoms”), and the right side of the web page (“Ethnicities most affected by Bloom syndrome” and “Read more at”).

Such a modular framework increases user comprehension by presenting layouts that are clear, progressive, and consistent. In particular, the grid system described in connection with FIGS. 15a-c enables graphical and text elements to be aligned in a uniform and predictable manner. Presenting content against this framework establishes a “visual rhythm” to help users perceive the deliberate informational hierarchy that is present on the web page. In some embodiments, the use of typography in connection with the grid system of FIGS. 15a-c may also increase overall user comprehension. For example, the font size and alignment of text elements relative to the baseline grid may be used (separately or in conjunction) to reinforce the informational hierarchy. In addition, the font size relative to the white space may be optimized to increase user comprehension. Use of the grid system of FIGS. 15a-c also results in a minimum amount of white space (for example, greater than 51%) relative to the displayed content on the web page. It is understood that the grid-style layout may be applied to the web page as a whole and/or to individual modules within the web page. There is no requirement that each module is similarly formatted.

Exemplary Web Pages Based on the Template

### Example 1

### Medical Condition

In one example, the physiological condition is a medical condition. The web page is constructed to contain only the First through Sixth Modules. In one specific embodiment, the modules are ordered as follows: 1-2-4-5-6. The Third Module may be place immediately following the Second, Fourth, Fifth, or Sixth Module.

In another embodiment, the web page further provides a Scientific Details Module, either above the First Module or below the last Module, or as a hyperlink to a separate web page. The Scientific Details Module optionally contains any one or more, but preferably all, of the submodules illustrated in FIGS. 12a-12f

### Example 2

### Trait

In another example, the physiological condition is a trait. The web page is constructed to contain the First, Fifth, Seventh, and Eighth Modules. In one specific embodiment, the modules are ordered as follows: 1-7-5-8. Optionally, the Seventh Module is repeated one, twice, thrice, or more, each presenting user genetic information on a different trait. Accordingly, the Fifth Module would be repeated the same number of time, once for each of the different traits. Preferably, the Seventh and Fifth Modules for each trait are displayed consecutively to yield an ordering of modules as follows: 1-7-5-7-5-8. Optionally, the Eighth Module is repeated for each trait to yield an ordering of modules as follows: 1-7-5-8-7-5-8.

Optionally, the web page is constructed with at least one Ninth Module. Preferably, the Ninth Module is positioned below all of the Fifth, Seventh, and Eighth Modules.

Optionally, the web page also contains at least one Sixth Module. The Sixth Module may contain a recommendation for any one or all of the traits displayed on the web page. In one embodiment with multiple (e.g., two) traits, the modules are ordered as follows: 1-7-5-8-7-5-8-6, wherein the Sixth Module contains the recommendation arising from the analysis of all traits. In another embodiment with multiple (e.g., two) traits, the modules are ordered as follows: 1-7-5-8-6-7-5-8-6, wherein each of the Sixth Modules provides a recommendation based only on the analysis of the trait immediately preceding it. It is understood that not all trait analyses give rise to a recommendation. Accordingly, the Sixth Module may be omitted for any one or more of the displayed traits.

Optionally, the Second and Fourth Modules may be substituted for the Seventh Module. Although desirable, there is no requirement that the Second and Fourth Modules remain adjacent to each other.

In another embodiment, the web page further provides a Scientific Details Module, either above the First Module or below the last Module, or as a hyperlink to a separate web page. The Scientific Details Module optionally contains any one or more, but preferably all, of the First, Second, Third, Fourth, and Ninth Modules. In one embodiment, the modules are ordered as follows: 1-3-2-4-9. The Second Module optionally may be omitted. Optionally, the Seventh Module may be substituted for the Second Module.

### Example 3

### Wellness Condition

In another example, the physiological condition is a wellness condition. The web page is constructed with the First, Fifth, Seventh, and Eighth Modules. In one specific embodiment, the modules are ordered as follows: 1-7-5-8. Optionally, the Seventh Module is repeated one, twice, thrice, or more, each presenting user genetic information on a different wellness condition. Accordingly, the Fifth Module would be repeated the same number of time, once for each of the different wellness conditions. Preferably, the Seventh and Fifth Modules for each wellness condition are displayed consecutively to yield an ordering of modules as follows: 1-7-5-7-5-8. Optionally, the Eighth Module is repeated for each wellness condition to yield an ordering of modules as follows: 1-7-5-8-7-5-8.

Optionally, the web page is constructed with at least one Ninth Module. Preferably, the Ninth Module is positioned below all of the Fifth, Seventh, and Eighth Modules.

Optionally, the web page also contains at least one Sixth Module. The Sixth Module may contain a recommendation for any one or all of the wellness conditions displayed on the web page. In one embodiment with multiple (e.g., two) wellness condition, the modules are ordered as follows: 1-7-5-8-7-5-8-6, wherein the Sixth Module contains the recommendation arising from the analysis of all wellness conditions. In another embodiment with multiple (e.g., two) wellness conditions, the modules are ordered as follows: 1-7-5-8-6-7-5-8-6, wherein each of the Sixth Modules provides a recommendation based only on the analysis of the wellness condition immediately preceding it. It is understood that not all wellness condition analyses give rise to a recommendation. Accordingly, the Sixth Module may be omitted for any one or more of the displayed wellness conditions.

In another embodiment, the web page further provides a Scientific Details Module, either above the First Module or below the last Module, or as a hyperlink to a separate web page. The Scientific Details Module optionally contains any one or more, but preferably all, of the First, Second, Fifth, and Eighth Modules. In one embodiment, the modules are ordered as follows: 1-5-2-8. Optionally, the Seventh Module may be substituted for the Second Module.

### Example 4

### Other Reports

Other report formats may include modules ordered as follows: 1-5-2-8 and 1-5-7-8.

In the description above, for purposes of explanation only, specific nomenclature is set forth to provide a thorough understanding of the present disclosure. However, it will be apparent to one skilled in the art that these specific details are not required to practice the teachings of the present disclosure.

The language used to disclose various embodiments describes, but should not limit, the scope of the claims. For example, in the previous description, for purposes of clarity and conciseness of the description, not all of the numerous components shown in the figures are described. The numerous components are shown in the drawings to provide a person of ordinary skill in the art a thorough, enabling disclosure of the present specification. The operation of many of the components would be understood and apparent to one skilled in the art. Similarly, the reader is to understand that the specific ordering and combination of process actions described is merely illustrative, and the disclosure may be performed using different or additional process actions, or a different combination of process actions.

Each of the additional features and teachings disclosed herein can be utilized separately or in conjunction with other features and teachings for protective coverings. Representative examples using many of these additional features and teachings, both separately and in combination, are described in further detail with reference to the attached drawings. This detailed description is merely intended for illustration purposes to teach a person of skill in the art further details for practicing preferred aspects of the present teachings and is not intended to limit the scope of the claims. Therefore, combinations of features disclosed in the detailed description may not be necessary to practice the teachings in the broadest sense, and are instead taught merely to describe particularly representative examples of the present disclosure. Additionally and obviously, features may be added or subtracted as desired without departing from the broader spirit and scope of the disclosure. Accordingly, the disclosure is not to be restricted except in light of the attached claims and their equivalents.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

None of the pending claims includes limitations presented in “means plus function” or “step plus function” form. (See, 35 USC §112(f)). It is Applicant's intent that none of the claim limitations be interpreted under or in accordance with 35 U.S.C. §112(f).

1. A method for constructing a web page, comprising:
generating or obtaining an electronic template for a web page using a processor of a computing platform, the template comprising:
a title module for displaying a physiological condition name and a physiological condition description including one or more condition-associated genes, wherein the title module is the first module displayed on the web page;
a user information module for displaying a user's genetic information for at least one of the condition-associated genes displayed in the title module, the user information module abutting and being positioned below the title module;
an interpretation module for displaying interpretation information about an interpretation of the genetic information displayed in the user information module, the interpretation module being positioned below the user information module;
an informational module for displaying physiological condition information about the physiological condition displayed in the title module; and
a recommendation module for displaying recommendation information for user action based on the genetic information displayed in the user information module, the recommendation module being positioned below the interpretation module;
accessing one or more databases to obtain information displayed in any one or more of the title module, the user information module, the interpretation module, the information module, and the recommendation module.

2. The method of claim 1, wherein the template further comprises a test module for displaying intended use information about a test used to determine the user's genetic information, wherein the test module is positioned below the user information module, and wherein the method further comprises accessing a test database to obtain the intended use information about the intended use of the test and displaying intended use information in the test module on the web page.

3-6. (canceled)

7. The method of claim 1, wherein the genetic information is the total number of mutations detected by the test for the condition-associated genes.

8. The method of claim 7, wherein the genetic information is displayed as a numeral enclosed within a geometric shape, wherein the geometric shape comprises a color different from the color of the numeral.

9-10. (canceled)

11. A method for constructing a web page, comprising:
generating or obtaining an electronic template for a web page using a processor of a computing platform, the template comprising:
a title module for displaying a first trait name, wherein the title module is the first module displayed on the web page;
a combined user information/interpretation module for displaying a user's genetic information for the first trait displayed in the title module, or interpretation information about an interpretation of the genetic information, or both, the combined user information/interpretation module being positioned below the title module;
an informational module for displaying trait information about the first trait displayed in the title module, the informational module being positioned below the title module; and
accessing one or more medical databases to obtain the first trait name and displaying the first trait name in the title module on the web page;
accessing a results database to obtain the user's genetic information for the first trait, or accessing the one or more medical databases to obtain the interpretation information for the first trait, or both, and displaying the user's genetic information, interpretation information, or both for the first trait in the combined user information/interpretation module on the web page;
accessing the one or more medical databases to obtain the trait information and displaying the information about the trait in the informational module on the web page.

12. The method of claim 11, wherein the template further comprises a first inheritance module for displaying the relationship between the user's genetic information for the first trait and genetic information for the first trait from one or more related individuals, wherein computing platform compares the user's genetic information for the first trait to the at least one related individual's genetic information for the first trait and displays an inheritance result in the inheritance module, wherein the first inheritance module is positioned below the first combined user information/interpretation module.

13. The method of claim 12, wherein the first inheritance module further comprises a user interface to accept a user input identifying at least one related individual for whom genetic information is stored in the results database.

14. (canceled)

15. The method of claim 11, wherein the template further comprises a second combined user information/interpretation module for displaying a user's genetic information for the first trait displayed in the title module and a second informational module for displaying a user's genetic information for the first trait displayed in the title module, wherein the second combined user information/interpretation module and second informational module are positioned below the first combined user information/interpretation module and the first informational module.

16. The method of claim 15, wherein the template further comprises a second inheritance module for displaying the relationship between the user's genetic information for the second trait and genetic information for the second trait from the one or more related individuals.

17. The method of claim 11, wherein the template further comprises a non-genetic information module comprising a user interface for entering information about one or more user traits, and wherein the non-genetic information entered by the user is stored in the results database.

18. The method of claim 11, wherein the template further comprises a first recommendation module for displaying recommendation information for user action based on the genetic information, interpretation, or both displayed in the first combined user information/interpretation module, the first recommendation module being positioned below the first combined user information/interpretation module.

19. The method of claim 15, wherein the template further comprises a second recommendation module for displaying recommendation information for user action based on the genetic information, interpretation, or both displayed in the second combined user information/interpretation module, the second recommendation module being positioned below the second combined user information/interpretation module.

20. The method of claim 1, wherein the web page further comprises a grid system for partitioning the web page into:
a baseline grid comprised of squares, wherein each square has a first width; and
one or more columns.

21-22. (canceled)

23. The method of claim 20, wherein the grid system further comprises a structural canvas having a third width; and a content canvas having a fourth width, wherein the fourth width is less than the third width.

24. (canceled)

25. The method of claim 20, wherein at least one of the first module, second module, third module, fourth module, fifth module, and sixth module is associated with at least one of the one or more columns and wherein the one or more columns are divided into one or more column groups.

26. The method of claim 25, wherein one of the one or more column groups includes a graphical display element; and a textual display element associated with the graphical display element.

27. (canceled)

28. The method of claim 20, wherein one or more parameters of a textual display element are determined relative to the baseline grid.

29. (canceled)

30. A method for constructing one or more web pages, comprising
generating, using a processor of a computing platform, an educational module for displaying a tutorial associated with a carrier status report; and
generating, using the processor, the electronic template for a web page of claim 1.

31-35. (canceled)

36. The method of claim 1, wherein accessing one or more databases comprises:
accessing one or more medical databases to obtain the physiological condition name, the physiological condition description, and the condition-associated genes and displaying the information in the title module on the web page;
accessing a results database to obtain the user's genetic information for at least one of the condition-associated genes and displaying information about the at least one of the one or more condition-associated genes in the user information module on the web page;
accessing the one or more medical databases to obtain the interpretation information and displaying the interpretation in the interpretation module on the web page;
accessing the one or more medical databases to obtain the physiological condition information and displaying the information about the physiological condition in the informational module on the web page; and
accessing the one or more medical databases to obtain the recommendation information and displaying the recommendation in the recommendation module on the web page.

37. A web page rendering system comprising:
(a) a processor and memory configured to:
generate or obtain an electronic template for a web page, the template comprising:
a title module for displaying a physiological condition name and a physiological condition description including one or more condition-associated genes, wherein the title module is the first module displayed on the web page;
a user information module for displaying a user's genetic information for at least one of the condition-associated genes displayed in the title module, the user information module abutting and being positioned below the title module;
an interpretation module for displaying interpretation information about an interpretation of the genetic information displayed in the user information module, the interpretation module being positioned below the user information module;
an informational module for displaying physiological condition information about the physiological condition displayed in the title module; and
a recommendation module for displaying recommendation information for user action based on the genetic information displayed in the user information module, the recommendation module being positioned below the interpretation module;
access one or more databases to obtain information displayed in any one or more of the title module, the user information module, the interpretation module, the information module, and the recommendation module; and
(b) the one or more databases comprising the information displayed in any one or more of the title module, the user information module, the interpretation module, the information module, and the recommendation module.
